(19) United States
(12) Patent Application Publication
(10) Pub. No.: US 2026/0106217 A1
(43) Pub. Date: Apr. 16, 2026

(54) SOLID STATE BATTERY INCLUDING IONIC LIQUID CRYSTAL ELASTOMERS

(71) Applicants: Zakaria Siddiquee, Kent, OH (US); Antal Jakli, Kent, OH (US)

(72) Inventors: Zakaria Siddiquee, Kent, OH (US); Antal Jakli, Kent, OH (US)

(21) Appl. No.: 19/356,018

(22) Filed: Oct. 10, 2025

Related U.S. Application Data
(60) Provisional application No. 63/705,869, filed on Oct. 10, 2024.

(51) Int. Cl. H01M 10/0565; C09K 19/38

(52) U.S. Cl. CPC H01M 10/0565; C09K 19/3842; H01M 2300/0082

(57) ABSTRACT

Methods for making and embodiments of polymer electrolyte matrix comprising the cured product of a precursor solution comprising one or more liquid crystal elastomers, one or more ionic liquids, at least initiator, and an ionic salt, and optionally one or more plasticizers, and solid-state polymer lithium batteries comprising the polymer electrolyte membranes.

### CROSS-REFERENCE TO RELATED APPLICATIONS

The present application claims the benefit of U.S. Provisional Patent Application No. 63/705,869, filed on Oct. 10, 2024, which is incorporated herein in its entirety.

### FIELD OF THE INVENTION

Embodiments of the present invention provide battery devices with improved performance and safety, including at high voltages and high energy-densities. Specifically, the present invention provides embodiments of solid state batteries incorporating electrolyte comprising ionic liquid crystal elastomers.

### BACKGROUND OF THE INVENTION

Battery technology is vital to a number of important industries including electric vehicles (EVs), consumer electronics, grid storage applications, medical devices, aerospace and defense, portable power tools, and renewable energy systems. Conventional liquid electrolyte poses safety risks such as leakage and flammability. Lithium-ion batteries have several critical issues including the formation of lithium dendrites, which can cause short circuits and degrade battery life. Thus, there is a need for improved electrolytes to further develop batteries with enhanced mechanical stability and durability over a wide-range of operating conditions while also providing high ionic conductivity and current density, especially in high-performance, high-capacity, and high-capacity energy storage applications.

There is a pressing need to improve the electrolytes in lithium-ion batteries by identifying alternative materials that satisfy the energy, power, and safety demands of electrical energy storage systems. Inorganic ceramic electrolytes (ICE), solid polymer electrolytes (SPE), and recently, polymer electrolyte membranes (PEM) have emerged as potential candidates for high-power, high-energy-density electrochemical-energy storage systems. Compared to liquid electrolytes, solid polymer electrolytes have lower ionic conductivities (approximately 10⁻⁸ to 10⁻⁶ S cm⁻¹) due to their long chains and amorphous structure. It is a common practice to dissociate the lithium salt into a lithium cation and a counter organic anion in order to improve ion conduction. Additionally, dinitrile derivatives (NC—(CH2) n-CN) are used as plasticizers, such as succinonitrile (SCN, n=2), glutaronitrile (GLN, n=3), and adiponitrile (ADN, n=4), to ionize the salt as well as solubilize ionic species in order to expedite ion mobility to a level of 10⁻⁴-10⁻³ S cm⁻¹ at room temperature. The plasticizing strategy decreases the glass transition temperature (T_{g}) of the polymer matrix by enhancing segmental chain dynamics, which, in turn, promotes higher ion conduction.

Currently, polyethylene oxide (PEO) based materials are the leading choice for polymer hosts in PEMs due to PEO's high dielectric constant, excellent ability to solvate lithium ions, while having favorable chain flexibility. Additionally, PEO is valued for its ease of preparation, cost-effectiveness, reasonable electrochemical stability, and safety features. Standard linear PEO-based PEMs typically show low ionic conductivities (≤10⁻⁶ S cm⁻¹) at room temperature (RT) due to the high crystallinity of the PEO chains. To improve ionic conductivities various approaches, such as block copolymer electrolytes, crosslinked polymer electrolytes, interpenetrating network polymer electrolytes, and composite polymer electrolytes, have been proposed with promising results. Despite this, most PEO-based PEMs exhibit lithium-ion transference numbers (the fraction of the total electric current carried in an electrolyte by a positive ion) below 0.6. To achieve acceptable battery performance, solid-state polymer lithium batteries (SSPLBs) using these PEMs generally need to operate at around 60° C., because of their limited ionic conductivities and high electrode/electrolyte interfacial resistances.

Consequently, there is a need for an optimized PEM with highly selective lithium ion transport characteristics both in bulk and at interfaces to enable SSPLBs to function effectively at room temperature (RT).

The concept of using fluid ionic liquid crystals (iLCs) with ion channels as ion conductive films and iLCs based PEM in SSPLBs has been shown using imidazolium salts in iLC as able to form liquid crystals for long enough alkyl chains. There is still a need for improved PEM compositions that maintain orientational order over a wide temperature range and demonstrate contraction at higher temperatures to thereby reduce pressure on electrode surfaces.

### SUMMARY OF THE INVENTION

One or more embodiments of the present invention provide a polymer electrolyte matrix comprising the cured product of a precursor solution, the precursor solution including one or more liquid crystal elastomers, one or more ionic liquids, and at least one photoinitiator.

Yet other embodiments of the present invention provide a solid-state battery comprising the polymer electrolyte matrix according to one or more embodiments of the present invention.

Further embodiments of the present invention provide methods for making a polymer electrolyte matrix according to one or more embodiments of the present invention.

Additional embodiments of the present invention provide liquid crystal elastomer based polymer electrolyte matrix including at least one monomer, at least one chain extender, at least one crosslinker, at least one ionic liquid, and at least one lithium salt.

Further embodiments of the present invention provide methods for adjusting the homeotropic alignment of liquid crystal elastomers by forming a precursor mixture including at least one monomer, and an initiator and one or more solvents, heating the precursor mixture to obtain a precursor solution, adding at least one chain extender to the precursor solution, adding at least one crosslinker to the precursor solution, homogenizing the precursor solution, combining the at least one ionic liquid and the at least one ionic salt, combining the homogenized precursor solution and the combined ionic liquid and ionic salt, to generate a curable homogeneous precursor, optionally heating and cooling the curable homogenous precursor, providing a cylindrical mold, pouring the curable homogenous precursor into the cylindrical mold, performing a Michael-Addition Reaction to thereby obtain an elastomer, removing the elastomer from the mold, stretching the elastomer, UV-curing the stretched elastomer, and slicing the cured stretched elastomer.

### BRIEF DESCRIPTION OF THE DRAWINGS

FIG. 1 is an illustration of the molecular structures according to some embodiments of the present invention;

FIG. 2 is an illustration of a synthetic pathway of a liquid crystal elastomer according to an embodiment of the present invention;

FIG. 3 is a series of FTIR spectra, stretching vibration curves, and twisting plots of some embodiments of the present invention;

FIG. 4 is a series of SEM imagery of an embodiment according to the present invention;

FIG. 5 is a photographic view of an embodiment of the present invention undergoing stretch testing;

FIG. 6 is a series of photographic views of embodiments of the present invention in use testing;

FIG. 7 is a series of plots showing ionic conductivity of various embodiments of the present invention;

FIG. 8 is a plot showing chronoamperometry for an embodiment of the present invention;

FIG. 9 is a series of polarized optical microscopy images and photographic views of an embodiment according to the present invention;

FIG. 10 is a series of voltammetry curves of embodiments of the present invention;

FIG. 11 is a series of plots relating to charging and discharge cycling characteristics of embodiments of the present invention;

FIG. 12 is a schematic illustration of a cell including an embodiment of a polymer electrolyte matrix according to the present invention for lithium-ion transport pathways;

FIG. 13 is a schematic structural illustration of an embodiment of a polymer electrolyte matrix according to the present invention for the crosslinked network of main chains and a unit cell configuration;

FIG. 14 is an illustration of the molecular structures according to some embodiments of the present invention;

FIG. 15 is a schematic illustration of an assembly process according to an embodiment of the present invention;

FIG. 16 is a schematic illustration of an assembly process according to an embodiment of the present invention;

FIG. 17 is a series of plots relating to charging and discharge cycling characteristics of embodiments of the present invention;

FIG. 18 is a series of plots of linear sweep voltammetry of embodiments of the present invention;

FIG. 19 is Arrhenius plots of ionic conductivity versus temperature of embodiments of the present invention;

FIG. 20 is plots of the activation energy and transference number of embodiments of the present invention; and

FIG. 21 is a series of plots of charge-discharge curves at room temperature for embodiments of the present invention.

### DETAILED DESCRIPTION OF ILLUSTRATIVE EMBODIMENTS

### Introduction

Embodiments of the present invention are based, at least in part, on the discovery of improved electrolytes for use in solid-state batteries. Embodiments of the present invention provide electrolytes comprising ionic liquid crystal elastomers (iLCEs) compositions. Various electrolytes according to the present invention are suitable for use in a polymer electrolyte matrix (PEM), which may then be integrated into solid-state lithium batteries (SSPLBs) to thereby provide solid ionic liquid crystal elastomers-based SSPLBs. Embodiments of iLCEs according to the present invention advantageously maintain orientational order over a wide range of operational temperatures. Further, embodiments of iLCEs according to the present invention possess an ability to contract at higher temperatures, which thereby advantageously reduces the pressure on electrode surfaces. Without wishing to be bound by theory it is believed that the organized ion pathways can be solidified through photopolymerization to create nanostructured ion-conductive electrolyte networks.

Embodiments of the present invention advantageously provide iLCE-based solid electrolyte batteries with enhanced safety. Unlike conventional lithium-ion batteries, which use flammable liquid electrolytes and are prone to thermal runaway and fire hazards, solid-state batteries eliminate this risk due to their use of non-flammable solid electrolytes. This improvement in safety is crucial for applications where thermal stability is paramount, such as in electric vehicles and portable electronics. Additionally, solid-state batteries exhibit higher energy density, which can translate into longer driving ranges for electric vehicles and longer battery life for electronic devices. This is because solid electrolytes can support the use of metallic lithium anodes, which offer greater energy storage capacity than the graphite anodes typically used in lithium-ion batteries. Furthermore, solid-state batteries can potentially offer faster charging times and longer lifespans due to their improved chemical stability and reduced risk of dendrite formation, which can degrade battery performance over time.

### Ionic Liquid Crystal Elastomer Compositions

In some embodiments, ionic liquid crystal elastomer compositions according to the present invention include a liquid crystal elastomer (LCE) matrix and ionic liquids. Various ionic liquid crystal elastomers may be used in ionic liquid crystal elastomer compositions according to the present invention.

In some embodiments, the present invention includes liquid crystal elastomer matrix comprising one or more monomers. In some embodiments the LCE matrix comprises a combination of two monomers. In some embodiments, the LCE matrix comprises M1 and M2. M1 as discussed herein may be a monofunctional monomer and may impart flexibility upon the M2 network while sustaining the nematic phase through mutual alignment. Acrylate monomer (monofunctional acrylate, methacrylate, etc.) may be used as chain extended or side-branching to the liquid crystal network, but there is a possibility that the nematic-isotropic transition temperature may be suppressed to a lower temperature, which might limit the application temperature range of the nematic liquid crystal alignment. M2 may be a multifunctional crosslinker (e.g., bifunctional, trifunctional, tetrafunctional, etc.). For example, RM257 may be suitable as M2. In general, there are a wide range of liquid crystal elastomer materials that can be used for M1 and M2. Those discussed herein are simply non-limiting examples.

In embodiments employing two monomers for the LCE matrix, the monomer(s) M1, M2 don't have to be mono/bifunctional. All the liquid crystal polymer/monomers which can be polymerized into a solid film can replace either of M1 and M2. As noted above, M1 and M2 are used as polymer matrix in iLCEs. In principle, any polymer or monomer which has liquid crystalline phase can be used as polymer matrix of iLCEs. The polymers can be mainchain LC polymers, side chain LC polymers or combined networks. Without wishing to be bound by theory, M1 and M2 may be cross-linked simultaneously to obtain LCE co-networks/matrices.

Some typical liquid crystal polymer/monomer/crosslinker examples are provided in the following table 1:

TABLE 1
Examples of Liquid Crystal Polymer, Monomer, Crosslinker

| | | | | | Alignment |
|---|---|---|---|---|---|
| | Backbone | Cross-linkes | | Mesogen unit | method |
| Side-chain LCE [symbol] | Poly [symbol] 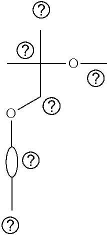 | LC | 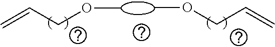 | 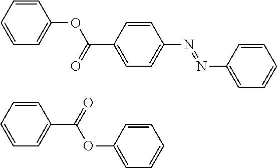 [SMILES: O=C(Oc1ccccc1)c1ccc(/N=N/c2ccccc2)cc1 ; O=C(Oc1ccccc1)c1ccccc1] | Mechanical stress |
| | | | [symbol] | | |
| | | Non-LC | 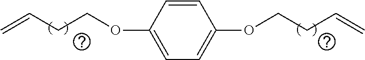 | 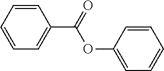 [SMILES: O=C(Oc1ccccc1)c1ccccc1] | |
| | | | [symbol] | | |
| | | Both | 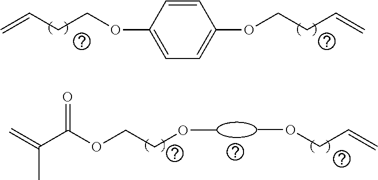 | 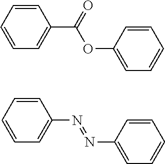 [SMILES: O=C(Oc1ccccc1)c1ccccc1 ; c1ccc(/N=N/c2ccccc2)cc1] | |
| | | | [symbol] | | |
| | Polyacrylate 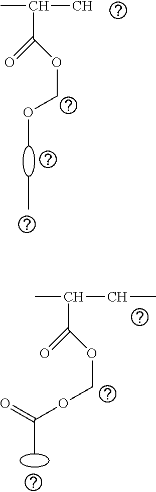 | LC | 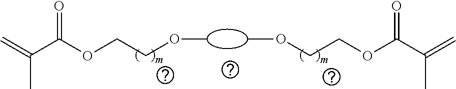 | 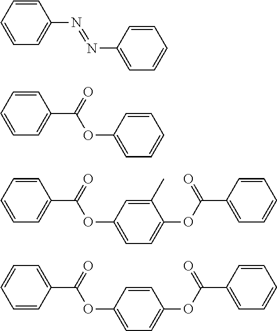 | Aligned Surfaces Electric field Magnetic field [symbol] Mechanical Stress light |
| | | | [symbol] | | |
| | | | 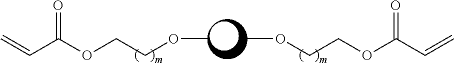 | | |
| | | | [symbol] | | |
| | | Non-LC | 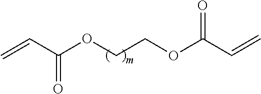 | | |
| | | | [symbol] | | |
| | | | 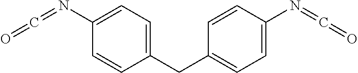 [SMILES: O=C=Nc1ccc(Cc2ccc(N=C=O)cc2)cc1] | | |
| | | | [symbol] | | |
| Main- chain LCE [symbol] | [symbol] 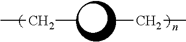 | LC | 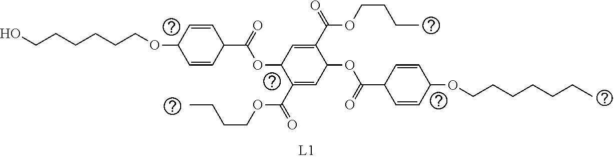 [SMILES: CCCCCCCOC1C=CC(C(=O)OC2C=C(C(=O)OCCCC)C(OC(=O)C3C=CC(OCCCCCCO)C=C3)C=C2C(=O)OCCCC)C=C1] | 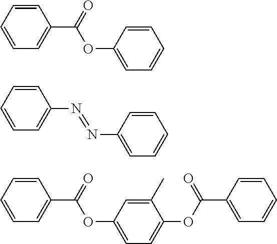 | Magnetic field Mechanical Stress |
| | | Non-LC | 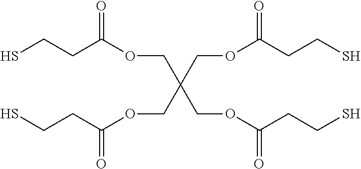 [SMILES: O=C(CCS)OCC(COC(=O)CCS)(COC(=O)CCS)COC(=O)CCS] | | |
| | Polyacrylate-based 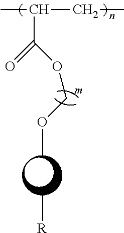 | LC | 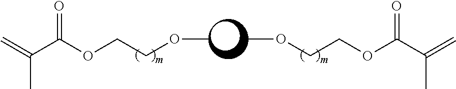 | | Mechanical Stress |
| | | | [symbol] | | |
| | Silicone-based 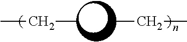 | Non-LC | 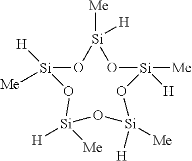 [SMILES: C[SiH]1O[SiH](C)O[SiH](C)O[SiH](C)O[SiH](C)O1] | | |
| | | | [symbol] | | |
| | Epoxy-based 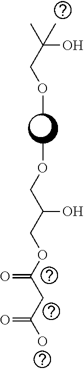 | Non-LC | 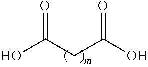 | 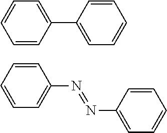 | Mechanical Stress |
| | | | [symbol] | | |

[symbol]

indicates data missing or illegible when filed

In some embodiments, the ratio of the amount of monomer in the ionic liquid crystal elastomer composition is not particularly limited. In one or more embodiments the ratio of M1 to M2 is 1:1 or greater, in other embodiments 2:1 or greater, in other embodiments 3:1 or greater, in other embodiments 4:1 or greater, in other embodiments 5:1 or greater, in other embodiments 6:1 or greater, in other embodiments 7:1 or greater, in other embodiments 8:1 or greater, in other embodiments 9:1 or greater, and yet in other embodiments 10:1 or greater. In one or more embodiments, the ratio of M2 to M1 is 1:1 or greater, in other embodiments 2:1 or greater, in other embodiments 3:1 or greater, in other embodiments 4:1 or greater, in other embodiments 5:1 or greater, in other embodiments 6:1 or greater, in other embodiments 7:1 or greater, in other embodiments 8:1 or greater, in other embodiments 9:1 or greater, and yet in other embodiments 10:1 or greater.

As discussed above, ionic liquid crystal elastomer compositions according to the present invention include ionic liquids dispersed within the liquid crystal elastomer matrix. In some embodiments, ionic liquids dispersed within the liquid crystal elastomer matrix include, without limitation, HMIM-TFSI (trifluoromethylsulfonyl) imide), EMIM (ethyl methylimidazolium)-TFSI, AMI M-TFSI (1 allyl-3-methylimidazolium bis(trifluoromethylsulfonyl) imide) EMI M-PF₆, EMI M-Br, EMIM I, etc. In further embodiments, ionic salts containing cations of different sizes and valences (i.e. Li+, K+, Mg+2, and Al+3), but with the same TFSI-anion may also be used.

In some embodiments the ionic liquid may have different sized cations and anions. In these and other embodiments, non-limiting alternatives examples of ionic liquids include those having a cation and an anion. In these and other embodiments the cation includes one or more cations selected from the group consisting of lithium ion, sodium ion, potassium ion, calcium ion, magnesium ion, aluminum ion, iron ion, zirconium ion, imidazolium ions, 1-ethyl-3-methylimidazolium ion, 1-butyl-3-methylimidazolium ion, 1-allyl-3-methylimidazolium ion, 1-butyl-2,3-dimethylimidazolium ion, 1-decyl-3-methylimidazolium ion, 1-hexyl-2,3-dimethylimidazolium ion, 1-hexyl-3-methylimidazolium ion, 1-(2-hydroxyethyl)-3-methylimidazolium ion, 2,3-dimethyl-1-propylimidazolium ion, 1,3-dimethylimidazolium ion, 1-methyl-3-n-octylimidazolium ion, 1-methyl-3-propylimidazolium ion, 1-methyl-3-pentylimidazolium ion), ammonium ions, amyltriethylammonium ion, butyltrimethylammonium ion, ethyl(2-methoxyethyl)dimethylammon ium ion, tetrabutylammonium ion), pyridinium ions, 1-butylpyridinium ion, 1-butyl-4-methylpyridinium ion), pyrrolidinium ions (1-butyl-1-methylpyrrolidinium ions, 1-ethyl-1-methylpyrrolidinium ions, i-methyl-i propylpyrrolidinium ions), phosphonium ions, and combinations thereof. In these and other embodiments the anion includes one or more anions selected from the group consisting of chloride ion, bromide ion, hexafluoroarsenic ion, hexafluorophosphate ion (PF6-), tetrafluoroborate ion, perchlorate ion, trifluoromethanesulfonic ion ([CF3SO3]-), [N(C2F5SO2)2]-, [N(C4F9SO2)(CF3SO2)]-, bis(trifluoromethane)sulfonimide ion ([N(CF3SO2)2j-), bis(oxalato) borate ion ([B(CO2)j-), tetrafluoroborate ion (BF4-), bis(fluorosulfonyl)imide ion ([N (FSO2)2]-), nitrate ion, hydrogen sulfate ion, AI2O7-, Al3Cli 0-, AICI4-, trifluoroacetate ion, trifluoro (trifluoromethyl) borate ion, thiocyanate ion, dimethyl phosphate ion, and combinations thereof.

In some embodiments, ionic liquid crystal elastomers according to the present invention include a combination of two or more ionic liquids dispersed within the liquid crystal elastomer matrix.

The person of ordinary skill in the art will readily appreciate that ionic liquid elastomer compositions according to the present invention include one or more initiators, which may also be referred to as a crosslinker and crosslinking agent. In some embodiments, the ionic liquid crystal elastomer compositions include at least one photoinitiator. Suitable photoinitiators for use in the present invention include, without limitation, Irgacure® 651, Irgacure® 619, and Rose Bengal photoinitiator which can be cured using UV light (e.g., wavelengths of 350-360 nm) or visible green light (e.g., wavelength of 540 nm). Other examples of photoinitiators include bis(2,4,6-trimethylbenzoyl)-phenylphoshineoxide (Irgacure® 819), Azobisisobutyronitrile (AIBN), Benzoyl peroxide and peroxide derivatives.

The ratio between monomer and initiator is adjustable according to the mechanical strength desired. Increased crosslinker generally leads to increased stiffness.

In some embodiments, ionic liquid crystal elastomer compositions may be characterized by the amount of a constituent by weight of the total composition. Non-limiting examples of ranges for the materials include polymer/monomer: about 5 to about 95 wt. %, based upon a weight of the total composition; and ionic liquid: about 5 wt. % to about 50 wt. % based upon a weight of the total composition. In one or more embodiments the amount of polymer/monomer is 25 wt. % or greater, in other embodiments 30 wt. % or greater, in other embodiments 35 wt. % or greater, in other embodiments 40 wt. % or greater, in other embodiments 45 wt. % or greater, in other embodiments 50 wt. % or greater, based upon a weight of the total composition

The ratio between monomer and crosslinker is adjustable according to the mechanical strength desired. Increased crosslinker generally leads to increased stiffness. In some embodiments, the amount of photoinitiator may be in the range of from about 1 wt. % to about 2 wt. % of the total composition.

### Plasticizer Additives for Ionic Liquid Crystal Elastomers Compositions

In some embodiments, ionic liquid crystal elastomer compositions according to the present invention include further additives. In one or more embodiments, ionic liquid crystal elastomer compositions according to the present include plasticizers. Without wishing to be bound by theory, plasticizers such as dinitriles, ethylene carbonate or propylene carbonate can be added into iLCE compositions for better ionic conductivity.

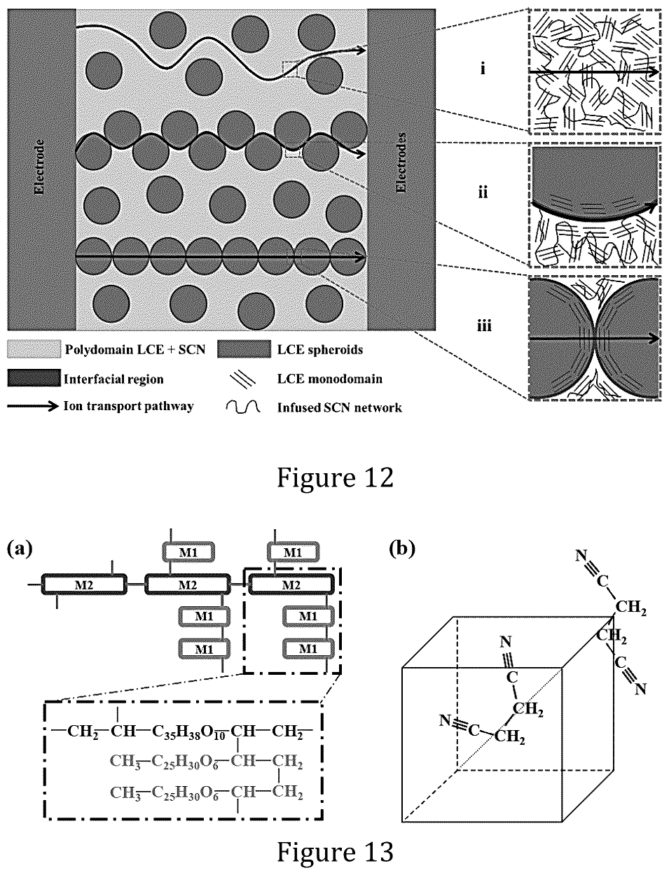

Further embodiments of the present invention provide iLCEs with succinonitrile (SCN) integrated into the ionic liquid crystal elastomer structures. The addition of SCN into the ionic liquid crystal elastomer structures advantageously enhances lithium ion transport efficiency. An exemplary framework for understanding ion transport in the SCN and LCE phase is provided in FIGS. 12 and 13. In the crosslinked LCE network, the LCE within the PEM forms polydomains, where the molecular director in each LC domain is oriented randomly, either as an SCN-infused co-network or a spherical droplet. As shown in FIG. 12, three potential regions (i, ii, iii) are identified as (i) the SCN-infused polydomain LCE co-network; (ii) the interfacial regions between the LCE spheres and LCE+SCN phases; and (iii) the dispersed phase-separated spherical LCE domains. Further, as shown in FIG. 13, ion transport in the SCN+LCE phase involves a combination of several mechanisms. The LCE is formed by a network of 87% monofunctional M1 monomers and 12% bifunctional M2 monomers. M2 primarily forms the polymer main chains, while M1 contributes to the side chains, as illustrated in FIG. 13. Polar ether-oxygen groups along these chains coordinate with lithium ions (Li⁺), enabling the ions to hop between and within polymer chains as Li—O complex break and reform under an electric field. The flexibility of the polymer side chains further promotes ion transport by allowing mobile segments to support ion movement.

In one or more embodiments, ionic liquid crystal elastomer compositions further include succinonitrile as a plasticizer additive. In these and other embodiments the concentration of succinonitrile is from 10 wt. % to 50 wt. %, in other embodiments from 15 wt. % to 50 wt. %, in other embodiments from 20 wt. % to 50 wt. %, in other embodiments from 25 wt. % to 50 wt. %, in other embodiments from 30 wt. % to 50 wt. %, in other embodiments from 35 wt. % to 50 wt. %, in other embodiments from 40 wt. % to 50 wt. %, in other embodiments from 45 wt. % to 50 wt. %, based upon the weight of succinonitrile to weight of the total composition.

In some embodiments, ionic liquid crystal elastomer compositions include surfactants. In these embodiments, ionic liquid crystal elastomer compositions include further additives known in the art.

### Polmer Electrolyte Membranes Including Ionic Liquid Crystal Elastomers Compositions

Embodiments of the present invention are directed towards iLCE-based electrolyte compositions suitable for use in and as polymer electrolyte matrices. In some embodiments, the electrolyte composition includes a cured residue of any ionic liquid crystal elastomer composition as described in any embodiment above and an ionic salt and may be referred to as an iLCE-based PEM. In these and other embodiments, the PEM comprises the cured residue of an iLCE composition that has solidified via photopolymerization in order to obtain an iLCE-based PEM including nanostructured ion-conductive electrolyte networks. In these and other embodiments, the iLCE-based PEM further comprises succinonitrile (SCN) dispersed within the nanostructured ion-conductive electrolyte networks.

In some embodiments, ionic salts suitable for use in the present invention are lithium salts. Non-limiting examples of lithium salts include lithium bis(trifluoromethylsulfonyl)imide (LiTFSI), lithium bis(fluorosulfonyl)imide (LiFSI), lithium hexafluorophosphate (LiPF₆), lithium trifluoromethanesulfonate (LiTF), and Li salts of borate or arsenate anions.

In one or more embodiments, ILCE-based PEMs are obtained by first providing precursor iLCE ingredients including one or more monomers and one or more initiators, optionally, providing further iLCE additives, providing an ionic salt, combining the ingredients and then crosslinking the mixture to thereby obtain the iLCE-based PEM. In these and other embodiments an iLCE-based PEM is provided through in situ photopolymerization iLCE precursors (M1, M2, and a photoinitiator)/SCN/lithium bis(trifluoromethylsulfonyl)imide (LiTFSI), to thereby obtain an iLCE-based PEM for use in ambient or room temperature SSPLBs. In these and other embodiments, the resulting iLCE-based PEM exhibits exceptional electrochemical properties, including high ionic conductivity, excellent compatibility with electrodes and effective suppression of lithium dendrite growth.

In some embodiments, the iLCE-based PEM is freestanding. In these and other embodiments, the iLCE-based PEM is flexible.

In some embodiments, the form of iLCE-based PEMs is not limited. Various shapes, sizes, and designs may be utilized according to a particular application for the ILCE-based PEM. In one or more embodiments, the form of iLCE-based PEMs is selected by utilizing a mold of a desired form that contains the iLCE precursor and ionic salt solution while curing the iLCE-based PEM solution.

In some embodiments, ILCE-based PEMs include the cured residue of one or more liquid crystal elastomers, one or more ionic liquids, one or more ionic salts, and one or more plasticizers. In these and other embodiments the one or more ionic liquids includes HMIM-TFSI. In these and other embodiments the one or more ionic salts includes LiTFSI. In these and other embodiments the one or more plasticizers includes SCN.

In some embodiments, the amount of each ingredient is expressed as a ratio of parts of the whole by weight. In one or more embodiments the amount of one or more liquid crystal elastomer is from 20 parts to 40 parts, the amount of one or more ionic liquids is from 10 parts to 25 parts, the amount of one or more ionic slats is from 10 to 25 parts, and the amount of one or more plasticizers is from 25 to 45 parts, based upon parts of the whole by weight. In one or more embodiments the ingredient ratios are 30 parts one or more liquid crystal elastomer, 17.5 parts one or more ionic liquids, 17.5 parts one or more ionic salts, and 35 parts one or more plasticizers, by parts of the whole by weight.

As discussed above, embodiments of the present invention provide methods of forming iLCE-based PEMs. In some embodiments the method of forming iLCE-based PEMs includes forming a precursor solution of one or more LCE solutions and photoinitiator. In some embodiments, the step of forming a precursor solution includes adding a first LCE solution, a second LCE solution, and a photoinitiator to thereby form the precursor solution. In some embodiments the method of forming iLCE-based PEMs includes adding an ionic liquid to the precursor solution. In some embodiments the method of forming iLCE-based PEMs includes adding an LiTFSI salt to the precursor solution. In some embodiments the method of forming iLCE-based PEMs includes adding SCN as a plasticizer to the precursor solution. In some embodiments the method of forming iLCE-based PEMs includes stirring the precursor solution. In some embodiments the method of forming iLCE-based PEMs includes heating the precursor solution. In some embodiments the method of forming iLCE-based PEMs includes mixing and handling the precursor solution in an inert environment, for example, an argon gas environment. In some embodiments the method of forming ILCE-based PEMs includes homogenizing the precursor solution prior to molding and photopolymerization. In some embodiments the method of forming iLCE-based PEMs includes adding the precursor solution to a mold and exposing the precursor solution in the mold to light, including for example, UV-light to cause photopolymerization and curing. In some embodiments the method of forming iLCE-based PEMs includes curing the precursor solution to thereby form the iLCE-based PEM.

Solid-State Polymer Lithium Batteries Including iLCE-Based PEMs

Embodiments of the present invention provide solid-state polymer lithium batteries (SSPLBs) incorporating iLCE-based PEMs according to the present invention. In some embodiments, SSPLBs according to the present invention include ILCE, SCN, and lithium bis(trifluoromethylsulfonyl)imide (LiTFSI).

Embodiments of the present invention further include cells comprising iLCE-based PEMs according to other embodiments of the present invention. In these and other embodiments the cells comprising iLCE-based PEMs have a coulumbic efficiency close to 100%. In one or more embodiments, cells comprising iLCE-based PEMs have a coulumbic efficiency of 99% or greater for at least 160 charging and discharging cycles. In one or more embodiments, cells comprising iLCE-based PEMs have a specific capacity retention of 80% or greater for at least 160 charging and discharging cycles.

### Lithium Ion Batteries and Alignment of LCE and Procedures

Without wishing to be bound by theory, liquid crystal elastomers merge the anisotropic molecular ordering of liquid crystals with the elasticity and toughness of crosslinked polymer networks. This unique duality enables LCEs to form self-supporting membranes that combine ion-conductive structure, mechanical robustness, and tunability under external stimuli. Historically, LCEs have been extensively studied for use in soft robotics, actuators, and sensors due to their ability to respond to electric fields, temperature, and light. However, their potential in electrochemical systems has only recently gained attention when it was demonstrated that LCEs can serve as viable hosts for lithium salts and ionic liquids, forming solid-state electrolytes with enhanced conductivity and thermal stability. It is thanks to the fact that some LC reactive monomers such as 1,4-Bis [4-(3-acryloyloxypropyloxy)benzoyloxy]-2-methylbenzene (RM257) and its homologs have ether-rich backbone which promotes Lit transport. They also have ability to form aligned mesophases, and provide mechanical integrity upon polymerization. The ordered nanostructures of LCEs also serve as effective ion-conduction channels. Additionally, the orientational elasticity of LCEs suppress the lithium dendrite formation, which is a critical issue for lithium metal batteries. Finally, in contrast to liquid electrolytes, homeotropically aligned liquid crystal elastomers shrink along the film thickness upon heating, thus preventing any overheating-related expansion or potential explosions.

Further embodiments of the present invention provide homeotropically aligned LCEs in lithium-ion batteries. In these and other embodiments, the fixed polymer backbone and crosslinking chemistry are maintained, and the alignment of the liquid crystal domains and concentration of the ionic liquid are varied to obtain different mesophase to improve lithium ion orientation. In these and other embodiments, the LCEs are prepared in nematic-phase in either planar or homeotropic configurations. Such embodiments are compatible with a broad range of ionic liquid loadings.

In one or more embodiments, LCE-based electrolytes according to the present invention include at least one monomer, at least one chain extender, at least one crosslinker, at least one ionic liquid, and at least one lithium salt. In these and other embodiments, the at least one monomer comprises RM257 monomer. In these and other embodiments, the chain extender comprises EEDET. In these and other embodiments, the crosslinker comprises PETMP. In these and other embodiments, the ionic liquid comprises BMIM-TFSI. In these and other embodiments, the lithium salt comprises LiTFSI.

In some embodiments, preparation of an LCE-based electrolyte according to the present invention includes forming a precursor mixture including at least one monomer, and an initiator and one or more solvents, heating the precursor mixture to obtain a precursor solution, adding at least one chain extender to the precursor solution, adding at least one crosslinker to the precursor solution, homogenizing the precursor solution, combining the at least one ionic liquid and the at least one ionic salt, combining the homogenized precursor solution and the combined ionic liquid and ionic salt, to generate a curable homogeneous precursor, optionally heating and cooling the curable homogenous precursor. In these and other embodiments where a planar alignment is desired, the method further comprises providing a sandwich cell type mold, filling the sandwich cell type mold with the curable homogenous precursor, performing a Michael-Addition Reaction to thereby obtain an elastomer, peeling off the elastomer and stretching the elastomer, and UV-curing the stretched elastomer. In other embodiments to obtain a homeotropic alignment, the method includes providing a cylindrical mold, pouring the curable homogenous precursor into the cylindrical mold, performing a Michael-Addition Reaction to thereby obtain an elastomer, removing the elastomer from the mold, stretching the elastomer, UV-curing the stretched elastomer, and slicing the cured stretched elastomer.

In order to demonstrate the practice of the present invention, the following examples have been prepared and tested. The examples should not, however, be viewed as limiting the scope of the invention.

### EXAMPLES

### Ionic Liquid Crystal Elastomer-Based Polmer Electrolyte Matrix Study

### Material Composition

Monofunctional acrylate monomer 4-(6-Acryloxy-hex-1-yl-oxy)phenyl-4-(hexyloxy)benzoate (M1) and bifunctional crosslinker 1,4-Bis-[4-(6-acryloyloxyhexyloxy)benzoyloxy]-2-methylbenzene (M2) were purchased from Synthon chemicals. Ionic liquid 1-Hexyl-3-methylimidazolium bis(trifluormethylsulfonyl)imide (HMIM-TFSI), photoinitiator 2,2-Dimethoxy-2-phenylacetophenone (Irgacure® 651), ionic salt lithium bis(trifluoromethylsulfonyl)imide (LITFSI), plasticizer succinonitrile (SCN) were acquired from Sigma-Aldrich, Milwaukee, US. Lithium metal disks (about 600 μm thick) and lithium iron phosphate (LFP) were purchased from MSE supplies.

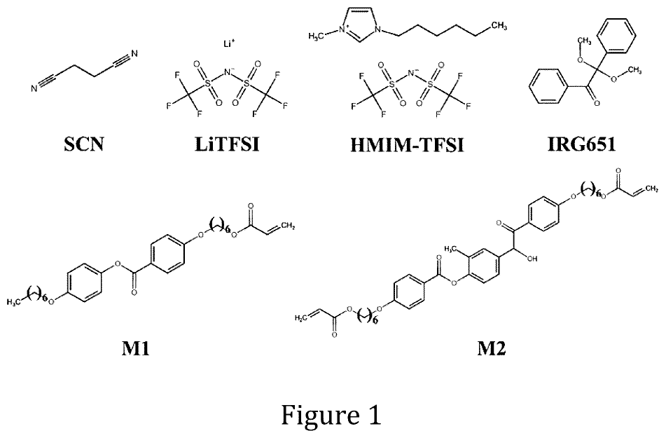

FIG. 1 provides the molecular structures of the components of an exemplary PEM: M1 and M2 are mesogenic units, HMIM-TFSI is the ionic liquid, Irgacure 651 is the photoinitiator, SCN is the platicizer, and LiTFSI is the ionic salt.

Synthesis of Ionic Liquid Crystal Elastomer (iLCE)

M1, M2, and the photoinitiator were mixed in 87:12:1 weight ratio to form the LCE precursors. Subsequently, an ionic liquid (HMIM-TFSI) was added to the LCE precursor solution and mechanically stirred using a magnetic stirrer for 24 h in an Ar-filled glovebox after heating to 80° C. to achieve complete mixing. The mixture was then stored in a glass amber vial to prevent photopolymerization and kept in the glovebox at room temperature for future use.

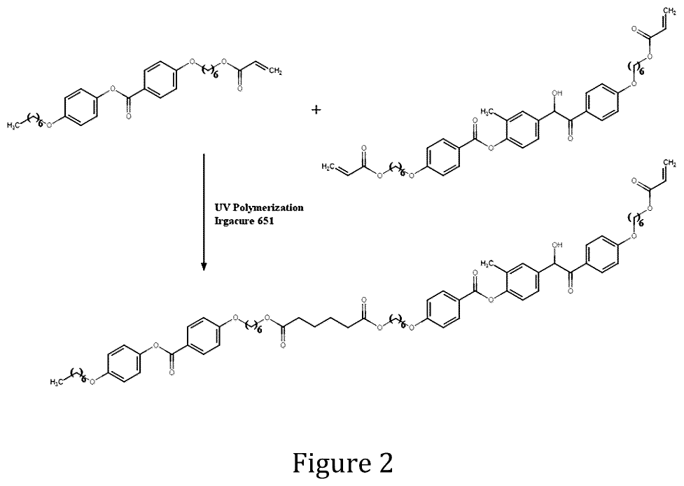

FIG. 2 shows a synthesis route of UV crosslinking reaction between M1 and M2 functional groups using a 1 wt % Irgacure 651photoinitiator and 365 nm wavelength UV photopolymerization to obtain LCE conetworks. In the PEM. The same reaction was undertaken in the presence of LiTFSI salt and SCN plasticizer that afforded a transparent, homogeneous film before and after UV curing, which is suggestive of a miscible character among the PEM constituents.

Fabrication of iLCE Electrolyte Membrane

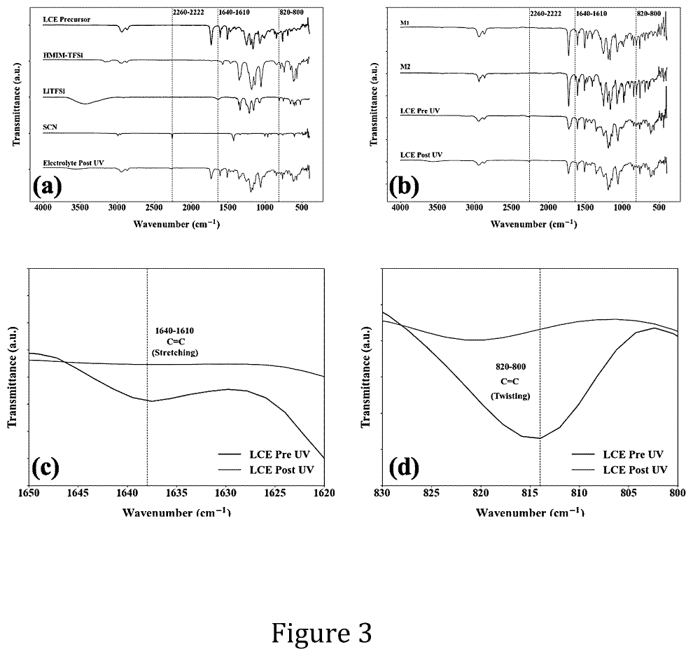

The binary eutectic mixture of LiTFSI and SCN at weight ratios of 25:50 was melt-mixed at 60° C. under Ar-gas environment. Subsequently, the homogeneously dissolved LiTFSI and SCN binary mixture was further mixed with the pre-mixed iLCE precursors at various wt % for an additional 24 h. The SPE membrane based on iLCE was prepared through UV photopolymerization of ILCE, SCN, and LITFSI. The homogeneous mixture was poured into a polytetrafluoroethylene mold with a thickness of 300 μm and a diameter of 15 mm approximately, where the solution was kept at various preset temperatures for 0.5 h. Subsequently, the electrolyte membrane was exposed to 365 nm UV light at 280 mW cm⁻² intensity for 30 s at the pre-set temperatures to activate the photoinitiator along with the mono- and bi-functional LCE monomers. These functional groups reacted with each other in the presence of SCN plasticizer and LiTFSI salt in various ratios. Upon curing, a binary iLCE conetwork-based electrolyte membrane (PEM) was formed with a film thickness of approximately 300 μm. Finally, the flexible electrolyte films were dried at RT under vacuum for 24 h. Fourier Transform Infrared Spectroscopy (FTIR) was performed on electrolyte film and individual components to check the formation of fully cross-linked LCE co-networks. The results of this are shown in FIG. 3 which shows (a) FTIR spectra of M1, M2, LCE before and after crosslinking between 4000 and 400 cm⁻¹; (b) FTIR spectra of LCE precursor, HMIM-TFSi, LiTFSi, SCN and polymerized PEM between 4000 and 400 cm⁻¹; (c) C═C symmetric and/or asymmetric stretching vibration peaks from PEM between 1640 and 1610 cm⁻¹; and (d) C═C twisting from 810 cm⁻¹ attributable to the C═C double bonds before (black) and after (blue) UV cross-linking under uniform UV exposure at 365 nm for 30 s.

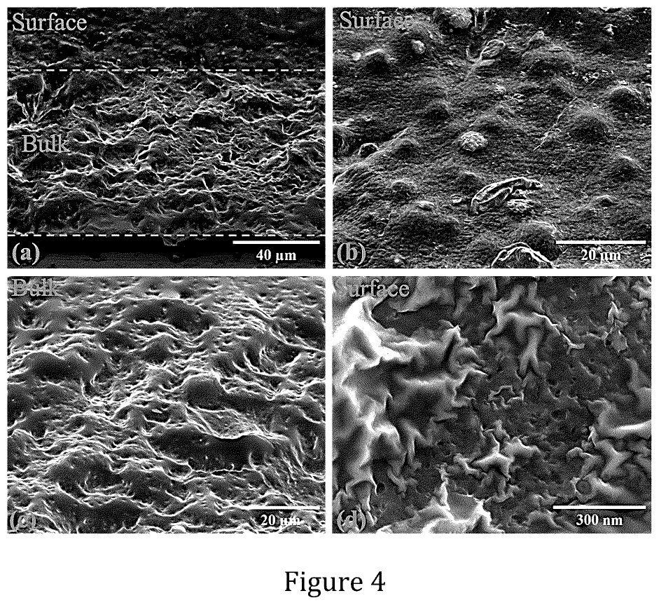

FIG. 4 shows SEM images. As SEM is conducted in vacuum, the low molecular weight components (ionic liquids) are evaporated, and their formerly occupied places appear dark. This provided information about the distribution of the ionic channels that is crucial for the operation of the battery. The images in FIGS. 4(a,c and c,d) show that the ionic liquid the polymers form bi-continuous structure, thus allowing ionic pathway from one end to the other. The diameter of the ion channels varies from 40 μm (see FIG. 4(a,b)) down to 100 nm range as seen in FIG. 4(d). FIG. 4(c) demonstrates phase separated polymer (LCE and SCN) domains. The minority component phase separates in spherical shape droplet from the continuous majority component, with the LCE being determined by the concentrations of the LCE and SCN. Importantly, as shown in FIG. 4(d), a minority droplet is shown which reveals that the ion channels interpenetrate even in the discontinuous minority domain.

### Measurement Methods: Ionic Conductivity

The ionic conductivity of the liquid crystal elastomer network was determined by means of AC impedance spectroscopy in order to decipher Li+transport behavior from an anode to a cathode through an electrolyte and vice versa. The ionic conductivity σ was calculated from the complex impedance Z* in accordance with the expression σ=w/(AZ), where w and A represent the thickness and the area of the PEM, respectively, and Z is the real component of Z′ at the imaginary impedance of Z″=0. An AC impedance spectrometer (HP4192A, Hewlett-Packard) was employed to determine the ionic conductivity of PEMs by scanning from 13 MHz to 5 Hz under an applied voltage of 10 mV at the temperature range between room temperature and 100° C. PEM samples were kept in a vacuum oven to remove any trapped bubbles. A homemade chamber having a cell dimension of 10 mm in length, 10 mm in width, and 1 mm in height was used for the AC impedance test. The PEM films were fully cured by UV curing and covered by polished stain-steel electrodes (10 mm×10 mm). The testing temperatures were 20, 30, 40, 60, 80, and 100° C., respectively. The symmetrical cells were kept at every testing temperature for 0.5 h to obtain thermal equilibrium before tests.

### Measurement Methods: Microscopic Measurements

Polarized Optical Microscopy (POM) analysis was performed using an Olympus BX60 polarizing optical microscope equipped with a Polaviz heating and cooling stage (the heating or cooling rate was 0.1° C. min⁻¹). The samples were sandwiched between two circular slides (the thickness and diameter of the circular slides were 0.14 and 15 mm, respectively).

Scanning Electron Microscopy (SEM) measurements were employed by using a Quanta450 FEG to determine the microstructure of electrolyte films (the samples were sputtered with Au for 30 s).

### Measurement Methods: Transference Number

To determine the transference number of lithium ions through the PEMs, Li/PEM/Li symmetric coin cells were assembled and measured by using Autolab PGSTAT302N galvanostat. A constant DC bias of 10 mV was applied to determine the initial (Iₒ) and steady-state currents (Iₛ), and the response of current was monitored for 3600 s until a steady-state current was reached. The before (R₀) and after (Rₛ) resistances of PEMs were determined by means of an impedance analyzer in the frequency range from 1 Hz to 100 kHz. The transference number (t+) of the PEMs was calculated in accordance with the following equation:

$${t}_{+} = \frac{{I}_{s} ( Δ V - {I}_{0} {R}_{0} )}{{I}_{0} ( Δ V - {I}_{S} {R}_{S} )}$$

where ΔV is the DC polarization voltage applied through the PEMs.

### Measurement Methods: Activation Energy

The activation energies were calculated by fitting the conductivity vs temperature data using the following Arrhenius equation and compared with respect to LCE and SCN wt % in PEM mixture:

$$σ = A {e}^{- \frac{{E}_{a}}{{k}_{B} T}}$$

where, σ=Conductivity (S/cm), Eₐ=Activation energy (eV), T=Temperature (° K) and k_{B}=Boltzmann's constant.

### Measurement Methods: Linear Sweep Voltammetry and Cyclic Voltammetry

To evaluate the electrochemical properties of the PEMs, an Autolab PGSTAT302N potentiostat was used to perform linear sweep voltammetry (LSV) and cyclic voltammetry (CV) tests at room temperature in coin-cell assembly configurations (CR2032). The LSV tests were conducted in a Li-metal/PEM/stainless-steel (SS) configuration from 1 to 5 V at a scan rate of 1 mV s⁻¹. In the CV test, coin cells assembled in the Li-metal electrode/PEM/LFP cathode configuration were run at the cathode potential range of 2.5-4 V at a scan rate of 5 mV s⁻¹ to evaluate their electrochemical stability and capacity retention at various potential ranges involving oxidation/reduction peaks.

### Measurement Methods: Charge and Discharge Cycling Tests

The galvanostatic charge and discharge cycling test was operated by using an 8-channel battery cycler (MTI corporation). The test was undertaken in cathode potential range (2.5-5.0 V) at various C-rates at room temperature.

### Characterization of ILCE Based Solid Polymer Electrolyte

To confirm the LCE crosslinking reaction, Fourier transform infrared (FTIR) spectroscopy (Bruker FTIR) was performed in transmission (T) mode. The PEM precursor solutions were placed on top of a KBr crystal, and IR spectra were collected before and after photopolymerization. The acquired spectra were an average of 64 scans with a resolution of 2 cm⁻¹ in a spectral range of 400-4000 cm⁻¹. FIG. 3 shows the M1, M2 and LCE before and after crosslinking. In the IR spectrum of the LCE before and after polymerization, the characteristic peak of C═C symmetric and/or asymmetric stretching and twisting bands were evident between 1640-1610, and 820-800 cm⁻¹ respectively. Figure S1b shows IR spectra of all the components of PEM and the polymerized electrolyte membrane where the appearance of CEN peak between 2260 and 2222 cm⁻¹ in the PEM spectra may be suggestive of partial phase separation. between SCN and LCE. Figure S1c-d shows that the C═C peak between 1640 and 1610 cm⁻¹, and the twisting C═C—H peak at 814 cm⁻¹ virtually disappeared in the IR spectrum of the LCE network as the C═C bonds were consumed during the UV crosslinking reaction, suggestive of the formation of fully cross-linked LCE co-networks.

To check the alignment of LCE droplets at the interface, a SCN/LCE (Liquid)/SCN sandwich cell was constructed. First a 300 μm thick SCN coating was applied to two glass slides. The slides were then bonded together with the SCN coatings facing inward, using Norland 65 UV glue and 700 μm silicone sheets as spacers, creating a 100 μm gap between the SCN layers. POM analysis showed an empty cell under cross polarizers. Then, a mixture of M1, M2, and Irgacure 651 in a weight ratio of 87/12/1 was prepared and introduced into the sandwich cell through capillary action. Subsequent POM analysis indicates that the filled cell displays color under cross polarizers, signifying planar alignment at the interface.

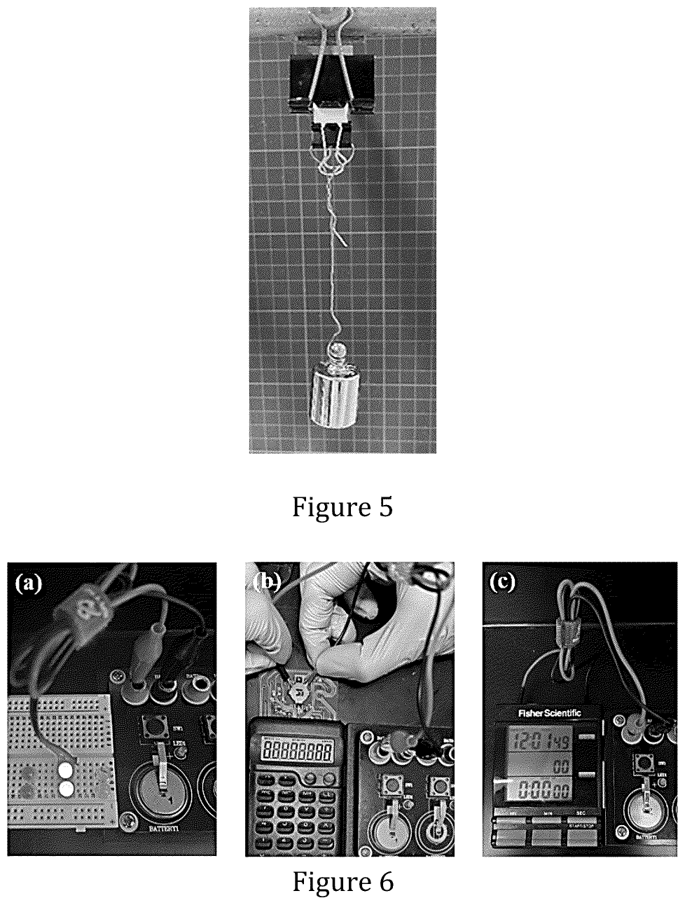

The PEM's stiffness was evaluated by incrementally adding weights and assessing its limits. Starting with 5 g increments, it was observed that the 2 mm×10 mm×10 mm (m˜0.26 g) PEM remained unaffected up to 60 g. Under the weight of 50 g mass, as depicted in FIG. 5 the PEM stretches significantly but retains its form without tearing. The weight of approximately 60 g mass causes the PEM to tear at the point where the bottom paper clip pinches it. It is possible that avoiding this pinching could allow the PEM to stretch further under stress.

As shown in FIGS. 12 and 13, the SCN crystalline phase belongs to the Im3m space group and contains two molecules per unit cell, as shown in FIG. 13. Its plastic phase flexibility arises from two types of molecular rotations, which generate twelve equilibrium configurations per site. These rotations create vacancies in the lattice that facilitate ion conduction. At temperatures below −30° C., only the —CN groups rotate, keeping the structure rigid and minimizing vacancies, leading to poor ion transport. In the plastic phase, between −30° C. and 60° C., both C—C and —CN bonds rotate, producing more vacancies and significantly improving ion conduction.

As illustrated in FIG. 12 region (i) ion transport below 60° C. occurs through a combination of segmental motion within the LCE network and interchain/intrachain ion hopping through vacancies in the SCN plastic crystal phase. When the temperature rises above 60° C., SCN melts, but the LCE network remains intact, providing mechanical stability and preventing the electrolyte from losing structural cohesion. This behavior confirms that the LCE structure serves as a stable framework, ensuring the system retains its integrity even when SCN enters the liquid state.

In the studied system, the LCE also separates from SCN and forms spherical regions, which act as dispersed domains within the polymer matrix, as shown in region (iii) in FIG. 12, contributing to the electrolyte's structural integrity. The studies of the POM textures of SCN/LCE/SCN sandwich cell indicate that at the interfaces between the LCE spheres and the surrounding matrix, the LCE adopts a planar alignment. Thus, it is proposed that the primary mechanism of ion transport along these LCE spheres involves interchain ion hopping. As lithium ions travel along the polymer chains, Li—O complexes are formed and reconfigured along the path, enhancing ionic mobility.

In the interfacial region, as depicted by region (ii) in FIG. 12, the LCE adopts a planar orientation, while the BCC crystals of SCN exhibit 12 possible molecular orientations in proximity. However, the higher Gutmann donor number 22 of ether (R—O—R′) groups compared to 15 of nitrile (—C≡N) groups, suggests that segmental motion and intrachain ion hopping plays a dominant role in ion transport along this region, as SCN has lesser tendency to solvate the Li+ cations at the interface.

Additionally, intrachain hopping of lithium ions is more efficient at the interface. Since the ion movement is constrained along the aligned polymer segments in a single direction, it occurs more rapidly than interchain hopping, which involves random directional jumps between polymer chains. This organized movement along the interface likely improves the overall ionic conductivity by creating low-resistance pathways for ion transport, reinforcing the importance of maintaining a well-aligned interfacial structure. LIGHTING TEST

A series of multicolor LED lamps were successfully lit up by the ILCE-based solid-state lithium-ion battery at room temperature. As shown in FIG. 6 CR2032 lithium coin cells based on iLCE powering (a) two blue LEDs; (b) 1.5V generic calculator; and (c) 1.5V digital stopwatch by Fisher Scientific. These tests proved the reliability and high specific energy of ionic liquid crystal elastomer-based lithium ion battery.

### Electrochemical Performance

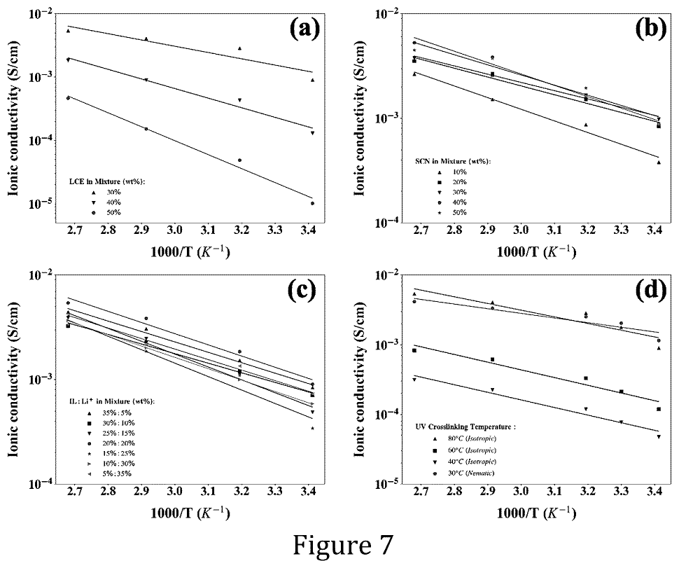

An impedance test for various PEM compositions was performed over a wide range of temperatures from 20 to 100° C. using a homemade rectangular cell having an area of 1 mm×1 mm and a 0.1 mm gap. The ionic conductivity σ(T) for each PEM composition was found to decrease with increasing temperature in reasonably good approximation following Arrhenius behavior,

$$σ ( T ) ∝ exp ( - \frac{{E}_{a}}{{k}_{B} T} ) ,$$

where k_{B}=1.38×10⁻²³ J/K, T is the temperature in Kelvin scale, and Eq is the activation energy. FIG. 7 shows the electric conductivity as a function of 10³/T(K) for various LCE FIG. 7(a), SCN FIG. 7(b), ionic liquid (IL) and Lit ratios FIG. 7(c), and at various crosslink temperatures FIG. 7(d). Specifically, as shown in FIG. 7: (a) variation of ionic conductivity versus reciprocal temperature for different ratios of LCE in electrolyte mixture, (b) variation of ionic conductivity versus reciprocal temperature for different ratios of SCN in electrolyte mixture, (c) variation of ionic conductivity versus reciprocal temperature for different ratios of HMIM-TFSI and LiTFSI in electrolyte mixture, and (d) variation of ionic conductivity versus reciprocal temperature for different crosslinking temperature of PEM. The straight lines are the best fits corresponding to the Arrhenius behavior. In comparison of 30, 40 and 50% of LCE contents FIG. 7(a), one finds that the highest ionic conductivity values (9.0×10⁻⁴ S cm⁻¹ at 20° C., and 5.39×10⁻³ S cm⁻¹ at 90-100° C.) were found for 30% LCE. The activation energies obtained from the slopes of the best fits are 0.197, 0.272 and 0.438 eV for the 30, 40 and 50% of LCE contents, respectively. This mean the material is becoming increasingly solid at increasing LCE concentration.

The effect of a plasticizer on lithium-ion conduction was examined by comparing 10,20,30,40.50 wt % SCN, keeping the liquid crystal elastomer composition to be the same (FIG. 4b). It is found that the ionic conductivity is increasing with increasing SCN concentration below 30 wt %. This is because an increasing plasticizer amount enhances the polymer chain dynamics, promoting ion conductions from an anode to a cathode and vice versa. At higher SCN concentrations the conductivity saturates providing about the same conductivity for the 40 and 50 wt % SCN. At increasing (10, 20,30,40, 50 wt %) plasticizer concentrations, the activation energies (0.222, 0.168, 0.157, 0.216 and 0.193 eV) decrease up to 30% in accordance with the enhanced polymer chain dynamics. An excessive plasticizer amount of SCN (>40 wt %) partially makes the PEM mechanically soft or fragile and partially leads to phase separation between the iLCE and SCN. The fragility compromises electrochemical stability at the PEM/electrode interfaces since the small-molecule weight SCN tends to ooze out to the PEM surface, the phase separation interrupts the ion channels that leads to saturation (an even slight decrease) of the conductivity and an increase of the activation energy.

The effect of the ionic liquid (IL) to Li salt ratio on the ionic conductivity was investigated by comparing the 5:35, 10:30, 15:25, 20:20, 25:15, 30:10 and 35:5 IL:Salt ratios so that the total weight percentage added to 40 wt % of the total mixture, keeping the same amounts of SCN and LCE FIG. 7(c). At room temperature the ionic conductivity of the 1:1 IL:LiTFSI PEM was the largest (1.76×10⁻³ S cm⁻³). The activation energies are found to be 0.198, 0.182, 0.244, 0.213, 0.256, 0.216 and 0.2 eV for the 5:35, 10:30, 15:25, 20:20, 25:15, 30:10 and 35:5 IL:Salt ratios, respectively.

The effect of polymerization temperature on the ionic conduction was examined by polymerizing in the nematic phase of the liquid crystal at 30° C. and in the isotropic phase at 40, 60, 80° C., during UV irradiation (FIG. 4d). Comparing samples polymerized in the isotropic phase, the Applicants find that the room temperature the ionic conductivity increases with increasing polymerization temperatures, most likely due to decreased crosslink density toward higher polymerization temperatures. Interestingly the conductivity of the sample polymerized in the nematic phase is even higher than the PEM polymerized at 80° C. This suggests that the elastomer network in the nematic phase forms a directional network which in turn act as ion conduction pathways for improved ion conduction. The slopes of the best fits gave 0.191, 0.22, 0.217, 0.133 eV for the samples polymerized in 30, 40, 60, 80° C., respectively.

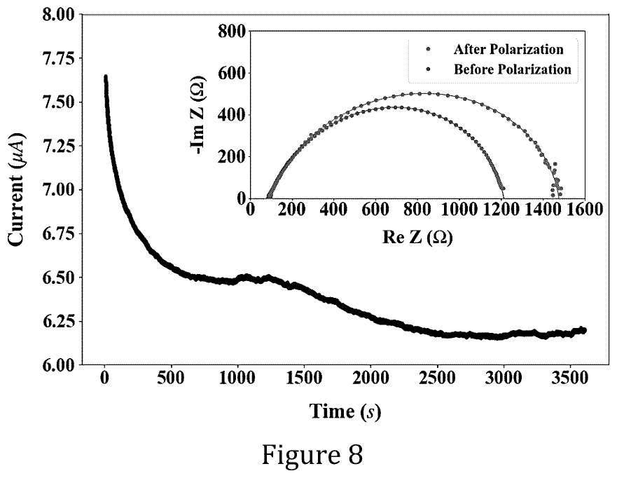

On the basis of these findings, subsequent experiments were focused on the LCE/HMIM-TFSI/LiTFSI/SCN: 30/17.5/17.5/35 PEM as it showed the highest (1.76×10⁻³ S cm⁻³) ionic conductivity at ambient temperature. Such conductivity value is comparable to those of lower end organic liquid electrolyte batteries.³⁴⁻³⁶ the Applicants conservatively chose this composition containing lower LCE content due to its mechanical integrity during assembling. Moreover, at room temperature this chosen 30/17.5/17.5/35 PEM exhibits an ion transference number (the ratio of the electric current derived from the cation to the total electric current) of t₊˜0.61, which is considerably higher than those (0.22-0.35) of organic electrolyte systems, suggesting the domination of ion transport by lithium cations over the TFSI anion. This is demonstrated in FIG. 8 which shows chronoamperometry of a symmetric (Li-PEM-Li) cell at ambient temperature in response to a U_{DC}=0.01 V bias for the LCE/HMIM-TFSI/LiTFSI/SCN: 30/17.5/17.5/35 PEM. The inset shows the Nyquist plot of the PEM impedance before DC polarization and after steady-state current conditions.

Structure of iLCE Electrolytes

Polarized Optical Microscopy (POM) studies before and after cross-linking, and inspection of mechanical properties of the LCE/HMIM-TFSI/LiTFSI/SCN: 30/17.5/17.5/35 PEM are shown in FIG. 9. Specifically, FIG. 9 shows POM images (a), (b) before cross-linking; (c), (d) after cross-linking; and (e), (f) inspection of mechanical properties of the 30/17.5/17.5/35 PEM after cooling at 0.1° C. min⁻¹ rate. POM studies showed that the mixture before crosslinking is in the isotropic phase above 34.2° C.; it has a nematic phase between 34° C. and 24° C. and it is crystalline below 24° C. FIG. 9(a, b) shows POM images of a 20 μm film between two glass plates (no rubbing, no ITO coat) before polymerization under cross polarizers in the isotropic (60° C.) and nematic (31° C.) phase. The isotropic structure is evidenced by the uniformly dark image. In the nematic phase the iLC prepolymer and the SCN plastisizer phase separate and form a structure similar to polymer dispersed nematic liquid crystals (PDLCs). The droplets exhibit four dark brushes (so-called Maltese crosses) along the cross polarizers indicating that the LC director orients either tangentially or radially inside the droplets. Because of the radial symmetry, the optical texture remains unchanged when the sample is rotated between the crossed polarizers. After UV induced crosslinking, the PDLC-type structure remains unchanged although the size of the iLCE micro droplets depends on the UV intensity, polymerization time, and temperature. At 280 mW cm⁻² UV intensity applied at 60° C. for 30 s cross linking time the packing of ILCE droplets is quite dense with droplets sizes approximately 3-10 μm as shown in FIG. 9 (c). After polymerization, the iLCE electrolyte shows nematic phase between 34° C. and 56° C. At higher temperatures, the droplets become isotropic, but the overall structure does not change and on cooling the nematic droplets appear again in their original locations. Heating to temperatures above 110° C. will start to melt the electrolyte membrane to liquid.

FIG. 9(d) shows the surface structure without polarizers after low intensity slow (10 mW cm⁻² for 10 min) polymerization. One can see that slow polymerization causes uneven distribution of droplet sizes and occasionally forms large domains of iLCEs in SCN matrix. Thus, the Applicants opted for fast polymerization at high intensities. FIG. 9(e) and (f) show 300 μm thick free-standing films of the 30/17.5/17.5/35 PEM at room temperature. In FIG. 9(e) one can see that the 300 μm thick film is self-standing and solid, while FIG. 9(f) demonstrates that the ILCE PEM is flexible. The toughness of a 2 mm×1 cm×1 cm (m˜0.262 g) thick film was tested by hanging weights up to 60 g when it started tearing up, as shown in FIG. 5.

### Cell Performance

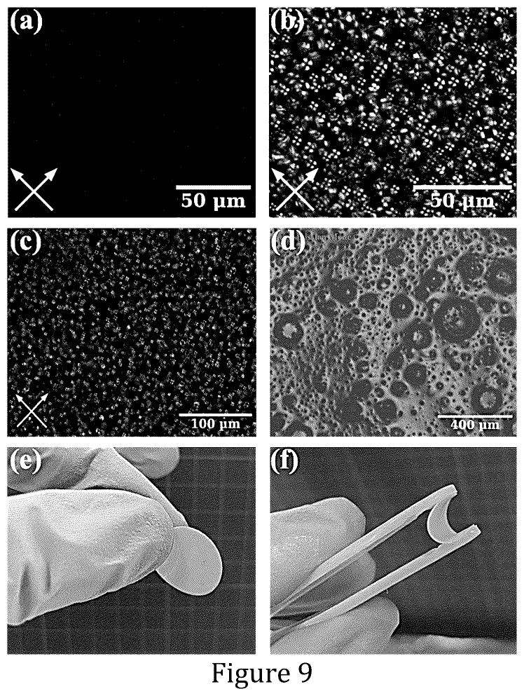

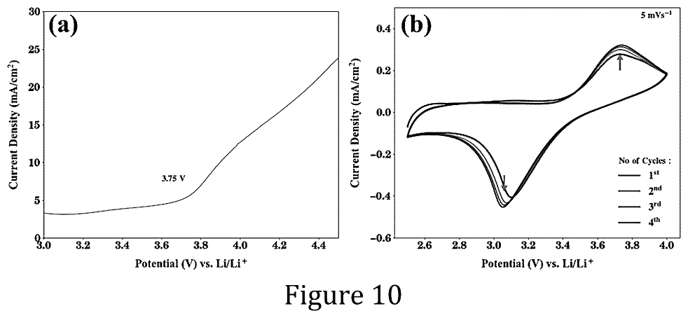

To understand the Li-ion storage mechanism in the PEM during prelithiation, cyclic voltammetry (CV) and galvanometric charge/discharge cyclic tests were carried out in Li metal/PEM/LiFePO₄ (LFP) configuration using CR2032 coin cells at various potential ranges 2.5-4.0 V. As shown in FIG. 10(a) and(b) a summary of voltammetry results with potential scan rate of 5 mV s⁻¹. In FIG. 10(a) a linear sweep voltammogram of PEM at 24° C. is shown. In FIG. 10(b) a cyclic voltammetry test of the Li/SPE/LFP configuration in cathode range (2.5-4.0 V) at 24° C. is shown. In the linear sweep voltammetry (LSV) scans, PEMs appear stable against the stainless-steel (SS) electrode up to 3.7 V, as indicated by the arrows at the onsets of the CV curves shown in FIG. 10(b).

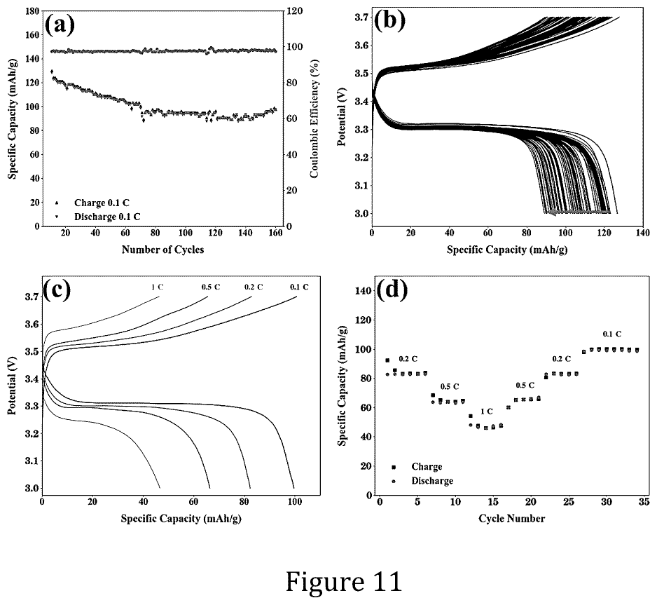

To identify the origin of oxidation and reduction peaks, a full battery cell was assembled in the Li-metal anode/SPE/LFP cathode configuration based on the PEM composition of 30/17.5/17.5/35 LCE/HMIM-TFSI/LiTFSI/SCN. The results of testing this full battery cell are shown in FIG. 11 for charge and discharge cycling characteristics of the ILCE based PEM in coin cell battery. Specifically FIG. 11 shows: (a) specific capacity and coulombic efficiency over 160 charge and discharge cycles; (b) charge and discharge profiles for Li/SPE/LFP cathode cells with a cathode range of 3.0-3.7V at a C-rate of 0.1 C at 25° C.; (c) charge/discharge curves of Li/SPE/LFP cell at different C-rates; and (d) the cycle performance of the Li/SPE/LFP battery during galvanostatic cycling at 0.1, 0.2, 0.5 and 1 C. When the CV test was carried out in 2.5 V to 4.0 V range using the LFP cathode, the oxidation and reduction peaks of the Li-metal anode and those of PEM can be observed in the corresponding potential ranges, which continue to increase with increasing number of cycles from 2nd to 4th. As can be expected, the oxidation and reduction peaks of the LFP cathode are observable in the vicinity of 3.6 V˜4.0 V and 3.0V, respectively, which fluctuates slightly with increasing the number of cycle as shown in FIG. 11(b). The continued increase in the peak strength may be attributed to the continued lithiation occurring in situ during repeated cycles, hereafter termed “in situ lithiation.” More importantly, these CV results are indeed reproducible, although the resulting oxidation and reduction peaks could increase or decrease depending on the competition between the in situ lithiation versus the capacity fading.

To further confirm the electrochemical stability of a PEM-based rechargeable battery, the galvanometric charge/discharge cycling test was performed at a 0.1 C rate from 3.0 V to 3.7 V FIG. 11 ((a) and (b)). Note, XY C-Rate=X (Current)×Y (Hours the battery can provide X current). The specific capacity was ˜100 mAh g⁻¹ and the Coulombic efficiency was ˜99%. To avoid any potential overcharging issues in the LFP cathode, the test was operated up to 3.7 V instead of 4.0 V. It should be pointed out that the specific capacity obtained from the PEM battery is 30 mAh g⁻¹ lower than the experimentally observed capacity of the LFP cathode (130 mAh g⁻¹).

FIG. 11(c), (d) show the charge/discharge voltage profiles and capability of the PEM at different C-rates. The cell clearly delivers outstanding average discharge capacities of 98.2, 83.4, 65.7, and 48.8 mAh g⁻¹ at C-rates (the ratio of the charging or discharging current (A) to the battery's capacity (Ah)) of 0.1, 0.2, 0.5, and 1 C at room temperature, respectively. It can be observed that the cell exhibits excellent reversibility and the charge-discharge capacities are almost the same at a given C-rate. Unfortunately, the cell shows poor capacity at higher C-rates. As reported by the manufacturer, the specific capacity of the LFP sheet that was used as cathode is 130 mAh g⁻¹. From cycles 80 to 160 and at 0.1 C rate, the ILCE/LiTFSI/SCN cell kept a discharge capacity around 98.8 mAh g⁻¹ and coulombic efficiency close to 100%. The stable and good interfacial properties are mainly due to the flexibility of the ILC-based electrolyte film, which causes excellent capacity retention and long cycling stability during cycling at RT.

Post-Cycling Characterization of iLCE-Based PEM

The FTIR spectra of the ILCE-based PEM before and after charge-discharge cycling was analyzed. By comparing these two states, the distinct peaks associated with Li+ and TFSI-ions can be clearly identified. The paired peaks at 1080 cm⁻¹ and 1100 cm⁻¹, related to C—O stretching, reflect the impact of Li+, as the intensity of the 1080 cm⁻¹ peak increases while the 1100 cm⁻¹ peak diminishes. During the charge-discharge process, the coordination between oxygen molecules and Li ions increases, leading to stronger absorption in the lithium-shifted vibrational bands. Several peaks corresponding to TFSI-appear at 740, 1180, 1327, and 1352 cm⁻¹. A noticeable shift near the 1327 cm⁻¹ wavelength suggests a structural change in the S═O bond.

Under crossed polarizers, the iLCE displays clear evidence of planar alignment along the radial direction, despite not being polymerized in a planar configuration. This alignment is due to the radial shear flow induced on the PEM during cell assembly. POM analysis shows the cycled iLCE PEM rotated under crossed polarizers. When positioned at 45° relative to the polarizer, the LCE exhibits a bright texture along the radial direction, while it appears dark when aligned with the polarizer's direction.

SEM analysis showed that bulk material doesn't change much post charge-discharge cycle. Even at the anode interface and cathode interface the bulk material doesn't show deviation from what was seen before cell assembly. However, the microscopy image of the anode side surface does show more porous structure at the surface compared to pre cell assembly possibly due to Solid Electrolyte Interphase (SEI) layer formation at the anode/PEM interface due to charge-discharge cycling.

### Conclusion

It was first designed and then successfully prepared a free-standing and flexible PEM through in situ photopolymerization of LCE/HMIM-TFSI/LiTFSI/SCN applicable for ambient temperature SSPLBs. The ILCE-based PEM exhibited high ionic conductivity (1.76× 10⁻³ S cm⁻¹ at 30° C.) and an electrochemical window of 3.7 V. The ILCE based PEM delivered a high ionic transference number (0.61) because iLCE could construct ion-conductive channels for more efficient transport of Li⁺. These outstanding comprehensive electrochemical properties enabled the ILCE-based PEM LFP/Li cells to maintain a capacity of 98.8 mAh g⁻¹ after 160 cycles under 0.1 Cat RT with a superior capacity retention of 99%. The excellent rate capability and low temperature performance of the cell also has been confirmed. the Applicants believe all the above excellent properties, along with the easy fabrication process, enable the PEM to have excellent potential for RT solid-state LIBs with high capacity and safety. These examples present the first and most promising results for a room temperature SSPLB utilizing an ionic liquid crystal elastomer-based PEM.

### Anisotropy in Liquid Crystal Elastomer Based Solid-State Batteries

### Material Composition

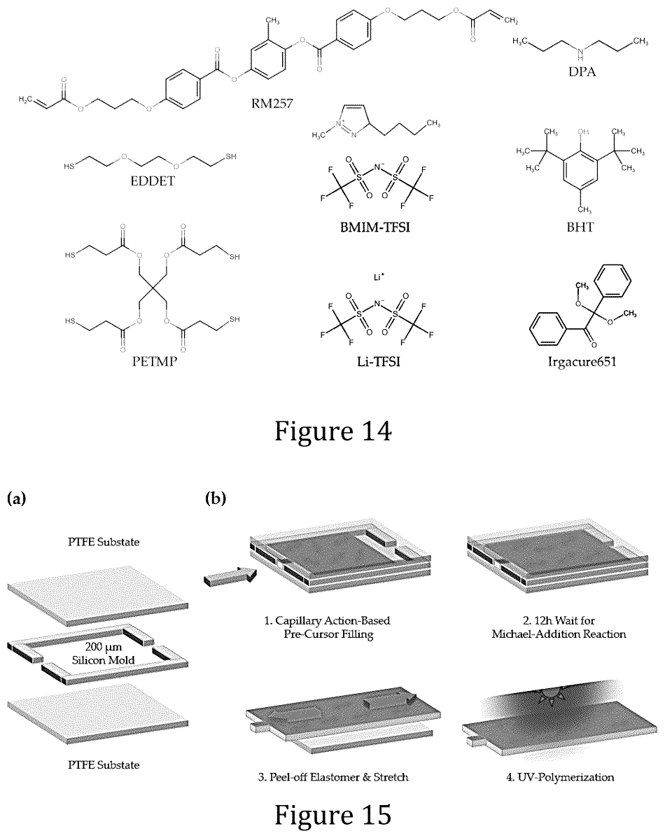

The solid polymer electrolytes developed in this study leverage the unique anisotropic structure and stimuli-responsive nature of ionic liquid infused liquid crystal elastomers, positioning them as promising candidates for lithium-ion battery applications. The bifunctional liquid crystal monomer 1,4-Bis [4-(3-acryloyloxypropyloxy)benzoyloxy]-2-methylbenzene (RM257, 97%, (see FIG. 14)) was obtained from SYNTHON-Chemicals (Germany) and used as the primary LC mesogen in the formulation of the LCE matrix. It contains ether oxygen groups that naturally facilitate the formation of two-dimensional ion-conducting nanochannels. These channels enable efficient lithium-ion transport by reducing migration barriers. The rigid benzene rings present in RM257 further strengthen the polymer network, contributing to its mechanical robustness.

Elastomers made solely from liquid crystal monomers are often too brittle for practical use. To address this, a small amount of thiol-functionalized chain extender 2,2-(Ethylenedioxy) diethanethiol (EDDET, 95%) was introduced to improve flexibility by elongating the polymer chains.

The ionic liquid 1-butyl-3-methylimidazolium bis(trifluoromethylsulfonyl)imide (BMIM-TFSI, 97%) was used to enhance ionic conductivity by providing a mobile ion transport medium within the polymer network.

Pentaerythritol tetrakis-(3-mercaptopropionate) (PETMP, 95%) was used as the tetrafunctional thiol crosslinker to construct a three-dimensional network. The Michael addition reaction was catalyzed by Dipropylamine (DPA, 99%), while 2,6-Di-tert-butyl-4-methylphenol (BHT, 99%) was added as a thermal inhibitor to prevent premature crosslinking. Lithium bistrifluoromethanesulfonimidate (LiTFSI, 98%), salt was used as the lithium-ion source due to its high electrochemical stability and compatibility with both the ionic liquid and the LCE matrix.

Photopolymerization was initiated using 2,2-Dimethoxy-2-phenylacetophenone (Irgacure-651, 99%) under UV exposure. Except for RM257, all chemical reagents were purchased from Sigma-Aldrich (Milwaukee, USA) and used without further purification unless otherwise stated.

Lithium metal disks (˜600 μm thickness) and lithium iron phosphate (LiFePO₄) cathode materials were sourced from MSE Supplies (Tucson, Arizona, USA) and used for battery fabrication and electrochemical testing.

### Fabrication of Cell Assemblies

All cell assembly procedures were conducted in a Purelab-HE-2 GB argon-filled glove box, with oxygen and moisture levels maintained below 0.1 ppm. Electrochemical performance was evaluated using CR2032-type coin cells. To assess ionic conductivity, a custom-designed symmetric Stainless Steel (SS)/LCE-SPE/SS cells with precise 1 mm×1 mm surface area and 0.1 mm thickness were constructed and evaluated using an Autolab PGSTAT302N electrochemical workstation. Electrochemical impedance spectroscopy was employed to determine the ionic resistance of the solid polymer electrolyte over a temperature range of 20° C. to 80° C. Impedance measurements were conducted over a frequency range of 0.1 Hz to 106 Hz with an applied AC voltage amplitude of 50 mV.

All cell assembly procedures were conducted in a Purelab-HE-2 GB argon-filled glove box, with oxygen and moisture levels maintained below 0.1 ppm. Electrochemical performance was evaluated using CR2032-type coin cells. To assess ionic conductivity, a custom-designed symmetric Stainless Steel (SS)/LCE-SPE/SS cells with precise 1 mm×1 mm surface area and 0.1 mm thickness were constructed and evaluated using an Autolab PGSTAT302N electrochemical workstation. Electrochemical impedance spectroscopy was employed to determine the ionic resistance of the solid polymer electrolyte over a temperature range of 20° C. to 80° C. Impedance measurements were conducted over a frequency range of 0.1 Hz to 106 Hz with an applied AC voltage amplitude of 50 mV.

For coin cell assembly, the LCE-Xn samples (where X=P for planar or H for homeotropic alignment, and n=1, 2, 3, 4, 5 corresponding to 0.05, 0.25, 0.5, 1.0, and 1.5 g of infused ionic liquid, respectively) were placed between a LiFePO₄ (LFP) cathode disc and a lithium metal anode. The lithium metal anodes were chemically polished inside an Ar-filled glovebox (PureLab HE) prior to assembly.

Galvanostatic charge-discharge tests and rate capability measurements were performed using a multichannel NEWARE Battery Testing System (5 V, 10 mA), operating within a voltage window of 2.0-5.0 V. The cycling performance of the Li/LFP cells was evaluated at various C-rates to investigate long-term electrochemical stability and capacity retention.

### Fabrication and Alignment of Lce Electrolytes

For c<20 wt % IL concentrations the RM257-based elastomer retains a stable nematic phase between 50-100° C., enabling a simple alignment process through thermal annealing between rubbed polyimide-coated substrates. In contrast, high IL concentrations destabilize the nematic phase-particularly in the absence of thiol-based chain extenders-shifting the isotropic-nematic transition temperature below room temperature. This shift inhibits effective alignment through surface treatment alone, necessitating a two-stage polymerization strategy.

To prepare the precursor mixture, 500 mg of RM257 was dissolved in 40 wt. % toluene along with 1.33 mg of BHT and 3.77 mg of Irgacure-651. The mixture was heated to 80° C. and then cooled to room temperature to acquire a solution. Upon cooling, 105.7 mg of EDDET and 47.1 mg of PETMP were added and homogenized using ultrasonic dispersion. The thiol group content was selected for optimal ionic conductivity while preserving structural stability. In parallel, 100 mg of LiTFSI was dissolved in specific amounts of BMIM-TFSI to prepare the IL component; five IL loadings were evaluated using 5.00 mg, 0.25 g, 0.50 g, 1.00 g, and 1.50 g of BMIM-TFSI, corresponding to IL mass concentrations of 0.67%, 25.00%, 40.00%, 57.14%, and 66.67%, respectively. This is shown in Table 2, below. The two solutions were rapidly combined and vortex-mixed for 5 minutes to generate a homogeneous precursor. To prevent crystallization of RM257, the solution was gradually reheated to 80° C. and then cooled to room temperature. At room temperature, 78.4 mg of DPA (2 wt. % in toluene) was added, and the mixture was vortexed until it transitioned from a low-viscosity, water-like fluid to a moderately viscous state, exhibiting increased resistance to flow. This change suggests the onset of weak viscoelastic behavior, though the mixture remained homogeneous and pourable. The precursor formulation was prepared through a two-stage thiol-acrylate Michael addition reaction.

TABLE 2
MATERIAL COMPOSITION OF ELECTROLYTES. THE CATALYST
SOLUTION IS PREPARED BY DISSOLVING A SPECIFIED
WEIGHT PERCENTAGE (WT. %) OF DPA IN TOLUENE.

| | | BMIM- | | | | | | |
|---|---|---|---|---|---|---|---|---|
| | RM257 | TFSI | LiTFSI | EDDET | PETMP | BHT | IRG651 | DPA |
| | (mg) | (mg) | (mg) | (mg) | (mg) | (mg) | (mg) | (mg) |
| LCE- | 500 | 5 | 100 | 105.7 | 47.1 | 1.33 | 3.77 | 78.4 (2 |
| X1 | | | | | | | | wt. %)* |
| LCE- | 500 | 250 | 100 | 105.7 | 47.1 | 1.33 | 3.77 | 78.4 (2 |
| X2 | | | | | | | | wt. %)* |
| LCE- | 500 | 500 | 100 | 105.7 | 47.1 | 1.33 | 3.77 | 78.4 (2 |
| X3 | | | | | | | | wt. %)* |
| LCE- | 500 | 1000 | 100 | 105.7 | 47.1 | 1.33 | 3.77 | 78.4 (2 |
| X4 | | | | | | | | wt. %)* |
| LCE- | 500 | 1500 | 100 | 105.7 | 47.1 | 1.33 | 3.77 | 78.4 (0.5 |
| X5 | | | | | | | | wt. %)* |

It was investigated how the LCE director alignment and the ionic liquid (IL) content influence the electrochemical performance. Specifically, it was examined how planar (P) and homeotropic (H) configurations of LCEs containing five different amounts of ionic liquid (IL). These samples are denoted as LCE-Xn where X indicates the alignment (P or H) and (n=1, 2, 3, 4 and 5) indicates the 5 compositions with increasing IL concentrations.

For planar alignment, a sandwich cell type mold was fabricated by assembling 200 μm-thick silicone sheets sourced from Generic (Peoples Republic of China) with 254 μm-thick Polytetrafluoroethylene (PTFE) sheets sourced from ePlastics (San Diego, USA). The PTFE sheets were cut and affixed to one side of glass substrates using Norland 65 UV-curable adhesive. The silicone mold was then shaped as shown in FIG. 15, and sandwiched between the PTFE-coated glass substrates with the PTFE surfaces facing the silicone spacer. The assembled mold was pressed and baked in a 25.4 torr vacuum oven at 100° C. for 1 hour to ensure a robust and sealed alignment cell.

As shown in FIG. 15, a schematic illustration of the fabrication process for a planar-aligned electrolyte including (a) Polytetrafluoroethylene (PTFE) sandwich cell mold used for precursor injection and alignment; and (b) Alignment and curing process: the mold is filled with the LCE precursor solution and left undisturbed for 24 hours to allow the Michael addition reaction to proceed. After initial network formation, the film is peeled from the mold, mechanically stretched to induce uniform planar alignment along the stretching, and subsequently UV-cured under 65 mW· [symbol] cm [symbol] \hat{ }(−2) UV light (320-390 nm) for 30 seconds to lock in the orientation and form the final elastomer electrolyte.

Homeotropic alignment was achieved using a cylindrical PTFE mold, by covering the inner surface of glass capillaries from Cole-Parmer (Vernon Hills, USA) with PTFE sheets. The PTFE was cut to size and adhered to the inner surface of the capillaries using Norland 65 adhesive. Once the Michael addition reaction initiated and the precursor began to set, the material was injected into the alignment cells via capillary action. The flow induced by filling promoted director alignment parallel to the flow, which was preserved as the network formation progressed. The filled cells were maintained at room temperature for 8 hours in darkness to allow completion of the initial stage of crosslinking, followed by demolding. The resulting LCE samples aligned along the axis of the cylinder were then mechanically stretched to 150% along the alignment axis and UV-cured at 65 mW·cm\hat{ }(−2) intensity to lock in the alignment using an IntelliRay 600 UV flood curing system with an operating UV range from 320-390 nm. The polymerization is completed rapidly between 15 and 30 seconds due to efficient thiol-((meth)acrylate) and ene-ene crosslinking, with all reactive groups consumed after the exposure period.42 FTIR analysis supports this observation, showing the disappearance of the characteristic S—H stretching peak at 2507 cm\hat{ }(−1)-attributed to RM257, EDDET, and PETMP—and the appearance of a C═C stretching peak at 1606 cm\hat{ }(−1), confirming complete conversion.

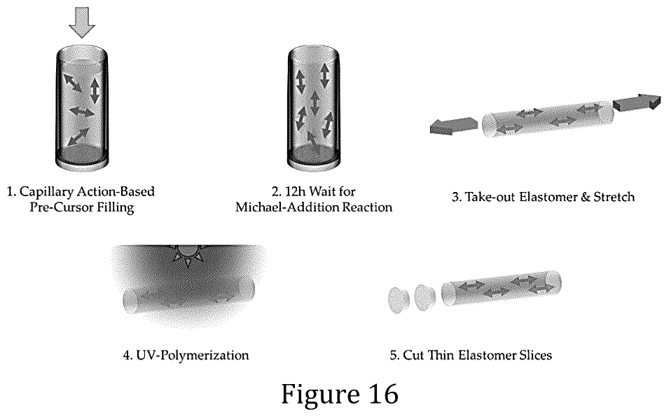

The cylindrical samples were then sectioned into 100 μm-thick discs with director alignment normal to the plates of the discs using a microtome to yield the final homeotropically aligned elastomer films as shown in FIG. 16.

As shown in FIG. 16, a schematic illustration for fabrication of the homeotropically aligned electrolyte (LCE-Hn) is provided. The LCE precursor solution undergoes initial thickening via thiol-acrylate Michael addition and then introduced into the cylindrical mold via capillary action. The confined geometry promotes director alignment along the cylinder axis. The mold is kept undisturbed at room temperature for 8 hours in darkness to allow the network to form. After demolding, the elastomer is UV-cured at 65 mW· [symbol] cm [symbol] \hat{ }(−2) UV light (320-390 nm) for 30 seconds. The resulting LCE-H is sectioned into 100 μm thick discs using a microtome to obtain the final homeotropically aligned electrolyte films.

### Nanostructure and Macroscopic Alignment

Wide-Angle X-ray Scattering (WAXS) results measured on planar and homeotropically aligned disc-shaped liquid crystal elastomer electrolytes were recorded, including planar LCE-P1 and homeotropic LCE-H1. LCE-P1 has two lobes left and right the direct beam indicating director alignment in the vertical direction. The 2D scattering pattern of LCE-H1 shows a ring pattern indicating director alignment along the x-ray beam. The homeotropic and planar cells exhibit very similar scattering patterns, with a prominent peak at Q≈1.4 Å\hat{ }(−1), corresponding to a lateral spacing between long axis of the mesogens of d=2π/Q≈4.5 Å. In the LCE-P1 electrolyte long-exposure WAXS measurements also show minor peaks oriented along the vertically oriented director at Q≈0.4 Å\hat{ }(−1), indicative of smectic layer spacings of d=21/Q≈15.7 Å. In this smectic regime, ion diffusion is enhanced along the layers (perpendicular to the director) compared to along the director itself, which may account for the higher ionic conductivity observed in LCE-P1 relative to LCE-H1. This observation aligns with previous studies of nematogen polymers, which report that the introduction of flexible spacers into the polymer backbone promotes the formation of smectic phases. In liquid crystal elastomers, longer flexible spacers such as thiol extensions allow mesogens to organize into layered structures more readily, stabilizing smectic domains.

The nematic order parameter(S) of the electrolyte films was calculated from the azimuthal intensity distribution of the wide-angle peak using Hermans-Stein orientation distribution function.

$$S = \frac{3 〈 {cos}^{2} θ 〉 - 1}{2}$$

where θ is the angle between the molecular director and the alignment axis and:

$$〈 {cos}^{2} θ 〉 = \frac{{\int }_{0}^{\frac{π}{2}} I ( θ ) sin {θcos}^{2} θ d θ}{{\int }_{0}^{\frac{π}{2}} I ( θ ) sin θ d θ}$$

Higher values of S (approaching 1) indicate strong molecular orientation, while lower values (near 0) reflect isotropic or poorly aligned systems. As expected, within the measurement error the order parameter is not influenced by the macroscopic alignment. LCE-X1, with 5 mg ionic liquid content had the highest nematic order parameter: ˜0.46±0.02. The samples LCE-X2 to LCE-X4 with intermediate ionic content have order parameters between 0.28 to 0.33. LCE-X5 with the largest ionic content exhibited the lowest value: 0.16±0.03, showing a systematic decrease of the nematic order parameter with increasing IL content. This shows that the IL disrupts molecular orientational order. After dried under vacuum at 100° C. for 24 hours, each sample was placed between crossed polarizers at four orientations—0°, 45°, 90°, and 135°—with 0° and 90° corresponding to the directions of the polarizer and analyzer, respectively. POM images were captured before and after the polymerization process to confirm the results.

After polymerization, the LCE-Pn (n=1-5) samples displayed extinction at 0° and 90°, with maximum brightness at 45°, confirming planar director alignment with somewhat decreasing quality with increasing IL content. In LCE-Hn (n=1-5) cells the POM images are dark for all n both at 0° and 45° as seen in POM images verifying director alignment very close to perpendicular to the substrates, especially for those with higher IL content.

Field Emission-Scanning Electron Microscopy (FE-SEM) images of 100 μm thick planar and homeotropic samples without prior drying were obtained. The IL contents appear in form of pores and indicate a correlation between IL concentration and pore formation within the polymer matrix.

### Electrochemical Properties

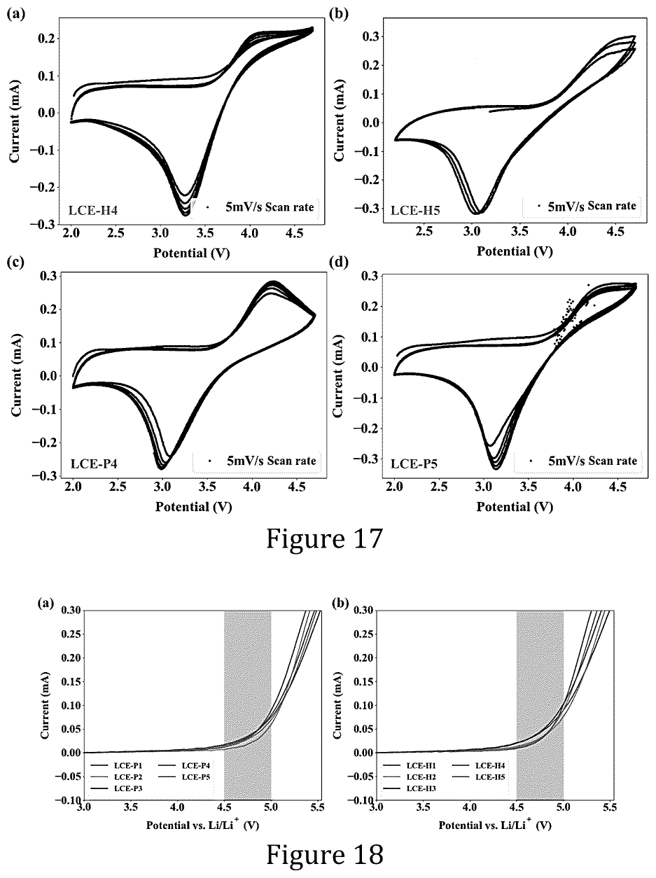

To investigate the redox behavior under operating conditions, Li/LCE-X4/LiFePO₄ and Li/LCE-X5/LiFePO₄ batteries were assembled and examined at 22.4° C. using cyclic voltammetry (CV). Redox peaks with symmetrical profiles were observed at approximately 4.2 V and 3.1 V for oxidation and reduction respectively (single measurement per specific full cells), indicating stable lithium-ion insertion and extraction (see FIG. 17). FIG. 17 provides cyclic voltammograms recorded at 5 mV/s scan rate for (a) Li/LCE-H4/LiFePO₄, (b) Li/LCE-H5/LiFePO₄, (c) Li/LCE-P4/LiFePO₄, and (d) Li/LCE-P5/LiFePO₄ cells. Although the curves vary, no distinct difference is evident between the planar and homeotropic electrolytes. The batteries were cycled five times at a scan rate of 5 mV·s⁻¹. Minor peak shifts during the first and later cycles are likely due to side reactions forming a solid electrolyte interphase (SEI) layer, possibly involving trace impurities. Cycles 2-5 overlap with each other, except for minor shifts in current, but the voltage peak locations remain consistent, indicating good oxidation and reduction stability of the LCE-X electrolytes.

Linear sweep voltammetry (LSV) was performed on Li/LCE-Xn (n=1-5) half-cells at 22.4° C. to evaluate the onset oxidation potentials of the electrolytes. They are determined from the intersection of tangents drawn to the non-faradaic (background) region where the current is minimal, and the faradaic (reaction) region, where the current increases significantly. This value was found to be approximately 4.8V (1-time measurement per half cells), as highlighted in the 4.5-5.0 V region in FIG. 18(a) for planar and FIG. 18(b) for homeotropic alignment.

The temperature dependence of ionic conductivity (o) was investigated using electrochemical impedance spectroscopy (average of 3 measurements per specific electrolyte). The ionic conductivity was calculated using the equation:

$$σ = \frac{l}{A \times {R}_{b}} ,$$

where l is the thickness of the electrolyte film, Rb is the bulk resistance obtained from the Nyquist plots, and A is the contact area of the Stainless Steel (SS) electrodes.

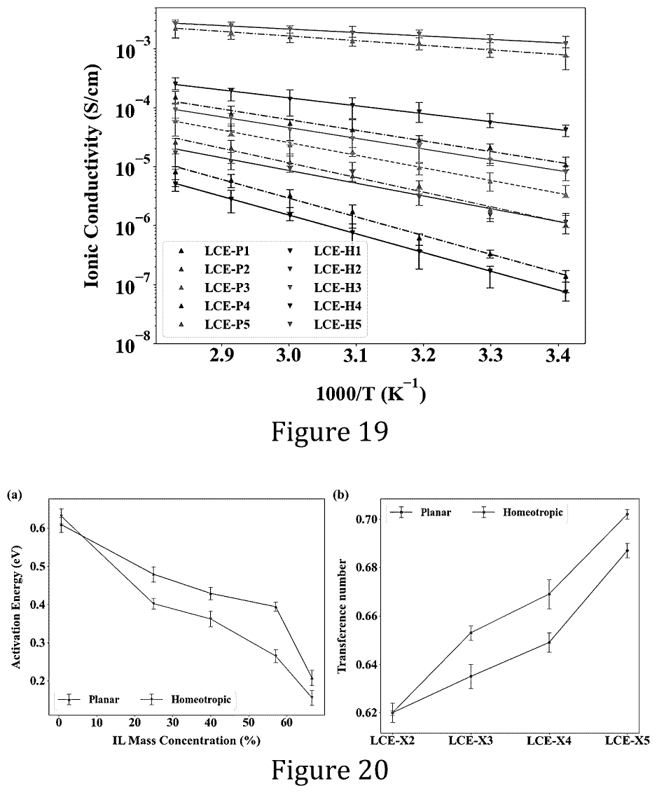

FIG. 19 includes Arrhenius plots of ionic conductivity versus temperature of LCE electrolytes for planar (upright triangles fitted with dashed lines) and homeotropic (downward triangles fitted with solid lines) alignments.

Tables 3 and 4, below, list the conductivity values at various temperatures for planar and homeotropic cells, respectively. By increasing IL concentrations, ionic conductivity improves markedly reaching σ>1 mS·cm\hat{ }(−1) for LCE X5 samples. This demonstrates that the ion-conducting properties of the material can be tuned by simply modifying IL content while maintaining the same polymer backbone. Moreover, differences in alignment between planar and homeotropic phases further impact transport properties, as the orientation of 2D channels changes ion mobility within the matrix. Interestingly, while at low IL concentrations (LCE-X1 and X2) the planar aligned cells have larger conductivities, at higher concentrations (LCE-X3-5) the homeotropicly aligned samples show larger conductivities. We propose that the larger conductivities in LCE-P1, 2 than of LCE-H1, 2 is due to the presence of the smectic clusters at zero and low IL concentrations. This facilitates molecular mobility and ion transport along the layers, providing an explanation for the higher ionic conductivity observed in LCE-P1 compared to elastomers with shorter spacers or homeotropic alignment.

TABLE 3
Average electrochemical impedance spectroscopy (EIS) conductivity vs. temperature
for planar electrolytes with increasing ionic liquid (IL) content.

| | | 20° C. | 30° C. | 40° C. | 50° C. | 60° C. | 70° C. | 80° C. |
|---|---|---|---|---|---|---|---|---|
| Ionic | LCE-P1 | 1.37 × | 3.33 × | 6.11 × | 1.73 × | 3.24 × | 5.83 × | 8.24 × |
| Conduct | | 10⁻⁷ | 10⁻⁷ | 10⁻⁷ | 10⁻⁶ | 10⁻⁶ | 10⁻⁶ | 10⁻⁶ |
| [symbol] | LCE-P2 | 1.02 × | 1.86 × | 4.71 × | 6.91 × | 1.18 × | 2.04 × | 2.56 × |
| | | 10⁻⁶ | 10⁻⁶ | 10⁻⁶ | 10⁻⁶ | 10⁻⁵ | 10⁻⁵ | 10⁻⁵ |
| | LCE-P3 | 3.36 × | 5.65 × | 9.64 × | 1.80 × | 2.35 × | 3.69 × | 6.00 × |
| | | 10⁻⁶ | 10⁻⁶ | 10⁻⁶ | 10⁻⁵ | 10⁻⁵ | 10⁻⁵ | 10⁻⁵ |
| | LCE-P4 | 1.06 × | 2.10 × | 2.79 × | 4.21 × | 5.44 × | 7.76 × | 1.50 × |
| | | 10⁻⁵ | 10⁻⁵ | 10⁻⁵ | 10⁻⁵ | 10⁻⁵ | 10⁻⁵ | 10⁻⁴ |
| | LCE-P5 | 7.75 × | 9.22 × | 1.24 × | 1.35 × | 1.61 × | 1.90 × | 2.22 × |
| | | 10⁻⁴ | 10⁻⁴ | 10⁻³ | 10⁻³ | 10⁻³ | 10⁻³ | 10⁻³ |

[symbol]

indicates data missing or illegible when filed

TABLE 4
Average electrochemical impedance spectroscopy (EIS) conductivity vs. temperature
for homeotropic electrolytes with increasing ionic liquid (IL) content.

| | | 20° C. | 30° C. | 40° C. | 50° C. | 60° C. | 70° C. | 80° C. |
|---|---|---|---|---|---|---|---|---|
| Ionic | LCE-H1 | 7.40 × | 1.69 × | 3.64 × | 7.51 × | 1.48 × | 2.81 × | 5.14 × |
| Conductivity | | 10⁻⁸ | 10⁻⁷ | 10⁻⁷ | 10⁻⁶ | 10⁻⁶ | 10⁻⁶ | 10⁻⁶ |
| S · cm⁻¹ | LCE-H2 | 1.14 × | 1.53 × | 3.04 × | 7.98 × | 9.30 × | 1.22 × | 1.70 × |
| | | 10⁻⁶ | 10⁻⁶ | 10⁻⁶ | 10⁻⁶ | 10⁻⁶ | 10⁻⁵ | 10⁻⁵ |
| | LCE-H3 | 8.07 × | 1.29 × | 2.19 × | 3.00 × | 4.25 × | 6.74 × | 9.22 × |
| | | 10⁻⁶ | 10⁻⁵ | 10⁻⁵ | 10⁻⁵ | 10⁻⁵ | 10⁻⁵ | 10⁻⁵ |
| | LCE-H4 | 4.21 × | 5.49 × | 8.42 × | 1.08 × | 1.38 × | 1.94 × | 2.50 × |
| | | 10⁻⁵ | 10⁻⁵ | 10⁻⁵ | 10⁻⁴ | 10⁻⁴ | 10⁻⁴ | 10⁻⁴ |
| | LCE-H5 | 1.22 × | 1.40 × | 1.76 × | 1.83 × | 2.13 × | 2.47 × | 2.63 × |
| | | 10⁻³ | 10⁻³ | 10⁻³ | 10⁻³ | 10⁻³ | 10⁻³ | 10⁻³ |

The higher conductivity in the homeotropic samples with high IL content can be understood by the following considerations. Lithium-ion transport in liquid crystal polymer electrolytes is governed by both mesogen alignment and molecular-level interactions, particularly Lewis acid-base coordination and the incorporation of ionic liquids. In planar alignment, mesogens lie parallel to the substrate, producing long lateral channels that enhance in-plane conduction. Lithium ions migrate efficiently along these channels by coordinating with electron-rich ether groups in the polymer backbone, which act as Lewis bases and donate electron density to stabilize Lit cations. This coordination promotes ion dissociation and hopping transport, further aided by segmental flexibility and free volume oriented laterally.^{50,51} However, when ions must traverse the film thickness, as in most battery architectures, planar alignment imposes tortuous pathways across mesogen sidewalls, reducing through-plane conductivity. In contrast, homeotropic alignment orients mesogens perpendicular to the substrate, establishing straight vertical pathways that optimize through-plane conduction. Here, ether-Lit interactions remain central, but segmental dynamics and free volume are aligned vertically, enabling efficient hopping between electrodes. The addition of ionic liquids further enhances transport by plasticizing the polymer, lowering the glass transition temperature, and creating liquid-like conduction domains. This process parallels the Grotthuss mechanism in aqueous electrolytes, where a hydrogen-bond network enables rapid proton migration and high conductivity. Moreover, ILs promotes ion dissociation and prevents ion-pairing, synergizing with Lewis acid-base interactions to increase both ion mobility (u) and carrier concentration (c), as reflected in σ=Σμ·q·c. This explains the higher conductivity observed in homeotropic samples at intermediate IL mass concentrations (0.67%-57.14%). At the highest IL concentration evaluated (LCE-X5), the system becomes oversaturated, disrupting ordered alignment and effectively turning the polymer matrix into a swollen network dominated by free ionic liquid. As a result, the conductivity of both planar and homeotropic samples converges, reflecting the bulk properties of the IL rather than structured transport through the polymer.

In FIG. 19 the ionic conductivity (log σ) was plotted against 1000/T (K⁻¹) for LCE-Xn (n=1-5) with both planar and homeotropic alignments at different ionic liquid concentrations. For all samples the plots can be fitted by linear function, indicating Arrhenius behavior:

$$σ ∝ exp ( \frac{- {E}_{a}}{{k}_{B} T} ) ,$$

where k_{B} is the. Boltzmann constant and Eₐ is the activation energy that can be obtained from the slope of the linear fit.

The values of activation energy, Eₐ are plotted in FIG. 20 as function of IL concentrations for both the planar and homeotropic samples (average of 3 measurements per specific electrolyte). For the pure and with c<25% IL concentrations LCEs, both alignments have activation energies of 0.61±0.01 eV. For c>25% (LCE-Xn (n=2, 3, 4) the homeotropic-aligned samples demonstrated lower activation energies suggesting more favorable ion conduction along the director. Just as for the conductivity values, for LCE-P5 and LCE-H5 samples the activation energies are again the same within the measurement error reflecting the bulk properties of the IL rather than structured transport through the polymer.

The lithium-ion transference number

$$( {t}_{L i}^{+} ) ,$$

which represents the fraction of the total ionic current carried by lithium ions and thus the efficiency of their migration, was obtained from EIS. The measurement involved chronoamperometry under a constant DC bias of 10 mV, where the initial current (I₀) and steady-state current (Iₛ) were recorded. Current responses were monitored for 10,000 seconds to ensure a stable steady-state value. The interfacial resistances before (R₀) and after (Rₛ) polarization were obtained from EIS. The

$${t}_{L i}^{+}$$

of the LCE-Xn was determined using the Bruce-Vincent-Evans equation.

$${t}^{+} = \frac{{I}_{S} ( Δ V - {I}_{0} {R}_{0} )}{{I}_{0} ( Δ V - {I}_{S} {R}_{S} )}$$

The test results for the Li/LCE-Xn/Li (n≥2) symmetric cells at room temperature were collected. LCE-X1 was excluded from testing due to its low ionic conductivity at room temperature, which significantly impaired battery performance. The measured

$${t}_{L i}^{+}$$

values range between 0.62 and 0.69, with the homeotropic alignment showing slightly higher transference numbers. A higher transference number contributes to improved performance by reducing concentration gradients during cycling, thereby minimizing the risk of dendrite formation and enhancing interfacial stability. These characteristics collectively support higher coulombic efficiency and longer cycle life, positioning aligned LCEs as promising candidates for next-generation solid-state lithium batteries.

For LCE-X2 to LCE-X4, the transference number increased approximately linearly with increasing ionic liquid (IL) content. This trend may be attributed to the positive role of IL in enhancing lithium-ion mobility. Specifically, IL incorporation can improve polymer chain flexibility, increase the amorphous regions of the electrolyte, and facilitate ion transport especially in the homeotropic alignment where the 2D channels are perpendicular to the electrodes. The 0.69 transference number exhibited by LCE-X5, is promising for fast-charging applications. However, there are trade-offs. While IL improves ion mobility, it also reduces the mechanical strength of the polymer network and makes alignment more difficult. As a result, even though LCE-X5 was found to achieve the highest lithium-ion transference number among the series, the alignment effect is disappearing. The alignment effects are most evident in LCE-Xn (n=3, 4), where a clear distinction is observed: the homeotropic samples LCE-H3 and LCE-H4 exhibit transference numbers of 0.65 and 0.67, while their planar counterparts LCE-P3 and LCE-P4 show slightly lower values of 0.63 and 0.65, respectively. Compared to traditional linear PEO-based solid polymer electrolytes, which typically exhibit transference numbers in the range of 0.1 to 0.25, the LCE-Xn materials offer a more efficient pathway for lithium-ion transport. Notably, higher

$${t}_{L i}^{+}$$

values help reduce concentration polarization and suppress dendrite formation, thereby enhancing the interfacial stability and compatibility between the electrolyte and electrode. This, in turn, leads to improved coulombic efficiency and overall battery performance.

### Li/LCE/LiPO4 Battery Performance

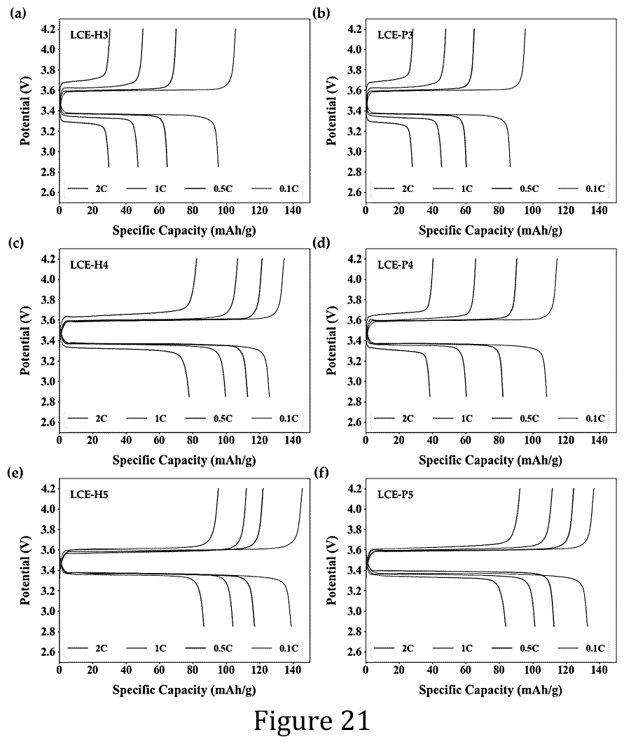

The batteries with only LCE-Xn (n≥3) were subjected to charge-discharge cycling at varying current densities at room temperature as LCE-Xn (n<3) showed ionic conductivity lower that ˜0.01 mS·cm⁻¹ which may compromise cyclability. Cycling tests were conducted at various C-rates (C-rate is a measure of the rate at which a battery is charged or discharged relative to its maximum capacity) to assess the durability of the different LCE systems. FIG. 21 shows selected charge-discharge curves at room temperature (22.4° C.) during cycling at 0.1, 0.5, 1 and 2 C-rates: (a) LCE-H3, (b) LCE-P3, (c) LCE-H4, (d) LCE-P4, (e) LCE-H5, (f) LCE-P5.

For planar-aligned samples, the initial discharge capacities at 0.1 C were 132.9, 108.4, and 86.6 mAh·g⁻¹ for LCE-P5, P4, and P3 respectively. In homeotropic alignment, the order was the same with slightly higher values: 139.0, 125.9, and 95.3 mAh·g⁻¹. LCE-X5 exhibited the highest specific capacity for both alignments, with only a small increase in capacity in the homeotropic vs planar aligned sample which makes sense as they have similar ionic conductivity (˜1 mS·cm⁻¹). A notable divergence was observed in LCE-X4 and LCE-X3 where the planar-aligned sample showed significantly lower specific capacities. This is likely due to alignment-dependent differences in ionic conductivity, which were also observed during conductivity measurements.

Concerning long-term stability, LCE-X4 demonstrated the most outstanding stability, retaining over 93% and 96% of its initial capacity after 300 cycles for homeotropic and planar alignments, respectively. LCE-X5 exhibited moderate retention, while LCE-X3 showed the most decline in performance, retaining only 83% and 84% for homeotropic and planar alignments, respectively. This underperformance can be attributed to its lower lithium-ion transference number and poor ionic conductivity, which likely accelerated degradation mechanisms.

Considering the initial charge-discharge stability at increasing current densities, the higher the ionic content, the larger are the overall initial and long-term discharge capacities. The fact that LCE-X5 which initially provided superior capacity, retained slightly less capacity over extended cycling compared to LCE-X4, may be attributed to high IL concentration in LCE-X5, which could reduce the impact of molecular alignment by disrupting the formation of well-defined ion-conducting channels. Consequently, the ion transport efficiency in LCE-X5 may not match that of LCE-X4 under certain conditions, especially as the structural ordering of the electrolyte diminishes.

The rate capability analysis further revealed that among all tested electrolytes, batteries using LCE-X4 and LCE-X5 exhibited the best initial rate performance. In contrast, LCE-X3 and LCE-X2 showed limited effectiveness under these conditions. Notably, most LCE-based batteries were able to recover nearly all their original capacity when the current density was returned to 0.1 C. This indicates that the LCE-Xn materials maintained structural and electrochemical integrity even under high-rate stress.

A more detailed investigation of LCE-X4 highlighted its excellent long-term performance. Lithium metal batteries assembled with a Li/LCE-X4/LiFePO₄ configuration retained over 78% and 81% of their initial capacity after 300 cycles at 1 C for planar and homeotropic electrolytes, respectively. Although a gradual decline in specific capacity was observed during prolonged cycling, likely due to lithium accumulation and uneven plating—the cell structure remained mechanically intact. The dendrite suppression capability of the LCE matrix contributed to delaying internal short circuits, even as lithium was gradually consumed from the electrolyte.

For post-cycle analysis LCE-H4 and LCE-P5 were selected. They were first vacuum-dried, then cooled to −70° C. using liquid nitrogen and fractured along the center of the circular LCE electrolyte discs. POM images and analysis reveal that, although Li-ion migration and the accumulation of LifePO₄ at the interface during cycling caused the images to appear darker, the molecular alignment remains largely unchanged. SEM images of the bulk cross-section reveal a porous structure with small particles, but the overall morphology remains consistent and shows minimal degradation of the elastomers, except for some merging of the LifePO₄ cathode material at the interface, indicating good contact at the cathode surface. LCE-H4 and LCE-P5 were selected for this analysis.

### CONCLUSION

As noted above, this study investigated the effect of macroscopic director alignment on the electrochemical performance of ionic liquid infused liquid crystal elastomer LCE-based solid polymer electrolytes for lithium-ion batteries. Notably, homeotropic alignment of LCE materials was applied for the first time in LIBs. By tuning the ionic liquid content and controlling the alignment (planar vs. homeotropic), we synthesized the LCE-Xn (n=1-5) series with intelligently tunable electrochemical behavior. It was found that that the incorporation of chain extenders significantly enhanced the mechanical properties of the electrolytes, enabling alignment even at high IL concentrations.

Two distinct lithium-ion transport mechanisms enabled by the anisotropic structure of LCEs, which govern ion mobility within the polymer matrix, were proposed. As a result, both planar and homeotropic alignments exhibit high ionic conductivity (up to 1±0.3 mS·cm⁻¹ at room temperature) and moderate activation energies. Notably, the homeotropic alignment shows higher conductivity because the ion-conducting channels are oriented along the director, normal to the electrodes, whereas in planar alignment, the director is parallel to the plates, limiting ion transport. At high ionic liquid concentrations, however, this directional advantage is diminished as the alignment is disrupted, and the differences between alignments become negligible. Despite comparable rate capability, cycling stability, and interfacial compatibility, clear changes in ionic liquid content lead to significant variations in ionic conductivity, lithium-ion transference number (t_{Li}⁺), and activation energy, highlighting the critical role of LCE alignment in optimizing lithium-ion transport for solid-state electrolytes. Among the tested samples, LCE-X4 demonstrated the best overall performance for both alignments. The Li/LCE-X4/LFP full cells delivered stable cycling for over 300 cycles at 1 C and room temperature, maintaining over 80% capacity retention. Furthermore, symmetric Li//LCE-Xn//Li cells (n=2, 3, 4, 5) exhibited excellent lithium plating/stripping stability, achieving more than 1000 hours of reversible cycling at room temperature.

The UV polymerization method used in our studies is not only simple and fast but also compatible with scalable roll-to-roll processing. This opens the door to low-cost, high-throughput production of high-performance polymer electrolytes, accelerating their integration into next-generation lithium battery technologies. By tailoring IL content and alignment, we can rationally engineer the final structure and electrochemical behavior of LCE-based electrolytes, enabling control over key metrics such as ionic conductivity, lithium-ion transference number, and electrochemical stability window. Given the intrinsic flexibility of these materials, our design framework emphasizes performance optimization over mechanical reinforcement, aiming to build intelligent solid-state battery systems with tunable properties.

Various modifications and alterations that do not depart from the scope and spirit of this invention will become apparent to those skilled in the art. This invention is not to be duly limited to the illustrative embodiments set forth herein.

What is claimed is:

1. A polymer electrolyte matrix comprising the cured product of a precursor solution comprising:
one or more liquid crystal elastomers;
one or more ionic liquids;
at least one initiator; and
an ionic salt.

2. The polymer electrolyte matrix of claim 1, wherein the one or more liquid crystal elastomers comprises a first liquid crystal elastomer and a second liquid crystal elastomer.

3. The polymer electrolyte matrix of claim 2, wherein the first liquid crystal elastomer is a monofunctional acrylate monomer.

4. The polymer electrolyte matrix of claim 3, wherein the second liquid crystal elastomer is a bifunctional monomer.

5. The polymer electrolyte matrix of claim 1, wherein the at least one initiator comprises a photoinitiator.

6. The polymer electrolyte matrix of claim 1, wherein the ionic salt is a lithium salt.

7. The polymer electrolyte matrix of claim 1, wherein the amount of one or more ionic liquids and ionic salt is from 3:1 to 1:3, by wt. % of the precursor solution.

8. The polymer electrolyte matrix of claim 7, wherein the amount of one or more ionic liquids and ionic salt is from 1.5:1 to 1:1.5, by wt. % of the precursor solution.

9. The polymer electrolyte matrix of claim 1, wherein the precursor solution further comprises one or more plasticizers.

10. The polymer electrolyte matrix of claim 9, wherein the one or more plasticizers comprises succinonitrile (SCN).

11. The polymer electrolyte matrix of claim 10, wherein the amount of succinonitrile (SCN) is from 20 wt. % to 40 wt. % by total weight of the precursor solution.

12. The polymer electrolyte matrix of claim 10, wherein the one or more liquid crystal elastomers comprises a monofunctional acrylate monomer and a bifunctional monomer, wherein the one or more ionic liquids comprises 1-Hexyl-3-methylimidazolium bis(trifluormethylsulfonyl)imide (HMIM-TFSI).

13. The polymer electrolyte matrix of claim 12, wherein the ionic salt is a lithium salt.

14. The polymer electrolyte matrix of claim 13, wherein the lithium salt is Lithiumbis(trifluoromethanesulfonyl)imide (LiTFSI).

15. The polymer electrolyte matrix of claim 14, wherein the amount of 1-Hexyl-3-methylimidazolium bis(trifluormethylsulfonyl)imide (HMIM-TFSI) and Lithiumbis(trifluoromethanesulfonyl)imide (LiTFSI) is from 3:1 to 1:3, by wt. % of the precursor solution.

16. The polymer electrolyte matrix of claim 14, wherein the amount of 1-Hexyl-3-methylimidazolium bis(trifluormethylsulfonyl)imide (HMIM-TFSI) and Lithiumbis(trifluoromethanesulfonyl)imide (LiTFSI) is from 1.5:1 to 1:1.5, by wt. % of the precursor solution.

17. A solid-state battery comprising:
a cathode;
an anode; and
the polymer electrolyte matrix of claim 1.

18. A method of making the polymer electrolyte matrix of claim 1, the method comprising the steps of:
providing a liquid crystal elastomer precursor solution including at least one liquid crystal elastomer;
providing at least one initiator and combining the initiator with the liquid crystal elastomer precursor solution;
providing at least one ionic liquid and combining the at least one ionic liquid with the liquid crystal elastomer precursor solution and initiator mixture;
providing an ionic salt and combining the ionic salt with the liquid crystal elastomer precursor solution, the initiator, and at least one ionic liquid mixture to thereby form the precursor solution;
mixing the precursor solution; and
curing the precursor solution to thereby form the polymer electrolyte matrix.

19. The method of claim 18, further comprising heating the precursor solution during the step of mixing the precursor solution.

20. The method of claim 18, wherein mixing the precursor solution comprises homogenizing the precursor solution.
